(19) United States
(12) Patent Application Publication
(10) Pub. No.: US 2026/0106659 A1
(43) Pub. Date: Apr. 16, 2026

(54) SPATIAL DIVERSITY FOR LOW-POWER WAKE-UP SIGNALS

(71) Applicant: QUALCOMM Incorporated, San Diego, CA (US)

(72) Inventors: Wei YANG, San Diego, CA (US); Yuchul KIM, San Diego, CA (US); Ahmed ELSHAFIE, San Diego, CA (US); Chao WEI, Beijing (CN)

(21) Appl. No.: 19/117,319

(22) PCT Filed: Nov. 14, 2022
(86) PCT No.: PCT/CN2022/131603

§ 371 Date: Mar. 31, 2025

(51) Int. Cl. H04B 7/06; H04L 27/26; H04W 52/02

(52) U.S. Cl. CPC H04B 7/0682; H04L 27/2601; H04W 52/0235

(57) ABSTRACT

Methods, systems, and devices for wireless communication are described. A transmitter may modulate a set of bits into a modulated sample sequence for transmission to a receiver. In some aspects, the transmitter may apply phase-cycling patterns to subsequences of the modulated sample sequence to generate phase-cycling modulated sample sequences and corresponding low-power signals. The transmitter may transmit the signals via respective antennas, which the receiver may receive at different times. Alternatively, the transmitter may generate the signals according to a transmission staggering pattern such that the signals are transmitted via different antennas at non-overlapping times or frequencies. The receiver may use envelop detection to detect the signals.

### CROSS REFERENCE

The present Application is a 371 national phase filing of International PCT Application No. PCT/CN2022/131603 by YANG et al., entitled “SPATIAL DIVERSITY FOR LOW-POWER WAKE-UP SIGNALS,” filed Nov. 14, 2022, which is assigned to the assignee hereof, and which is expressly incorporated by reference in its entirety herein.

### FIELD OF TECHNOLOGY

The present disclosure relates to wireless communication, including spatial diversity for low-power wake-up signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, one or more receivers may use a modulation scheme, such as on-off keying (OOK), to detect low-power wake-up signals. However, to receive such signals, the receiver may fail to meet the same coverage as for other channels.

### SUMMARY

The described techniques relate to improved methods, systems, devices, and apparatuses that support spatial diversity for low-power wake-up signals. For example, the described techniques provide for transmitting transmit modulated low-power wake-up signals according to a phase-cycling pattern or a transmission staggering pattern. In some cases, the transmitter may modulate one or more bits into a modulated sample sequence and apply phase-cycling patterns to subsequences of the modulated sample sequence to generate respective phase-cycling modulated sample sequences. The transmitter may transmit signals via respective antennas based on the phase-cycling modulated sample sequences, which the receiver may receive and decode via a single receive antenna. Alternatively, after modulating the bits into the modulated sample sequence, the transmitter may generate multiple signals from the modulated sample sequence and in accordance with a transmission staggering pattern, which may indicate to stagger transmission of the signals across different frequency subbands. The transmitter may transmit the signals via respective antennas and at non-overlapping times or frequencies in accordance with the transmission staggering pattern. In this way, the transmitter may create spatial diversity by transmitting the signals via separate antennas according to the phase-cycling pattern or the transmission staggering pattern, which may enable the receiver to operate at a low-power and receive the signals via a single antenna (e.g., using envelop detection).

A method for wireless communication at a transmitter is described. The method may include modulating one or more bits into a modulated sample sequence for wireless transmission to a receiver, applying a first phase-cycling pattern to a set of multiple subsequences of the modulated sample sequence to generate a first phase-cycling modulated sample sequence for transmission via a first transmit antenna, applying a second phase-cycling pattern to the set of multiple subsequences of the modulated sample sequence to generate a second phase-cycling modulated sample sequence for transmission via a second transmit antenna, transmitting a first signal via the first transmit antenna based on the first phase-cycling modulated sample sequence, and transmitting a second signal via the second transmit antenna based on the second phase-cycling modulated sample sequence.

An apparatus for wireless communication at a transmitter is described. The apparatus may include a processor, memory coupled with the processor, and instructions stored in the memory. The instructions may be executable by the processor to cause the apparatus to modulate one or more bits into a modulated sample sequence for wireless transmission to a receiver, apply a first phase-cycling pattern to a set of multiple subsequences of the modulated sample sequence to generate a first phase-cycling modulated sample sequence for transmission via a first transmit antenna, apply a second phase-cycling pattern to the set of multiple subsequences of the modulated sample sequence to generate a second phase-cycling modulated sample sequence for transmission via a second transmit antenna, transmit a first signal via the first transmit antenna based on the first phase-cycling modulated sample sequence, and transmit a second signal via the second transmit antenna based on the second phase-cycling modulated sample sequence.

Another apparatus for wireless communication at a transmitter is described. The apparatus may include means for modulating one or more bits into a modulated sample sequence for wireless transmission to a receiver, means for applying a first phase-cycling pattern to a set of multiple subsequences of the modulated sample sequence to generate a first phase-cycling modulated sample sequence for transmission via a first transmit antenna, means for applying a second phase-cycling pattern to the set of multiple subsequences of the modulated sample sequence to generate a second phase-cycling modulated sample sequence for transmission via a second transmit antenna, means for transmitting a first signal via the first transmit antenna based on the first phase-cycling modulated sample sequence, and means for transmitting a second signal via the second transmit antenna based on the second phase-cycling modulated sample sequence.

A non-transitory computer-readable medium storing code for wireless communication at a transmitter is described. The code may include instructions executable by a processor to modulate one or more bits into a modulated sample sequence for wireless transmission to a receiver, apply a first phase-cycling pattern to a set of multiple subsequences of the modulated sample sequence to generate a first phase-cycling modulated sample sequence for transmission via a first transmit antenna, apply a second phase-cycling pattern to the set of multiple subsequences of the modulated sample sequence to generate a second phase-cycling modulated sample sequence for transmission via a second transmit antenna, transmit a first signal via the first transmit antenna based on the first phase-cycling modulated sample sequence, and transmit a second signal via the second transmit antenna based on the second phase-cycling modulated sample sequence.

Some examples of the method, apparatuses, and non-transitory computer-readable medium described herein may further include operations, features, means, or instructions for multiplying a first subsequence of the set of multiple subsequences with a first phase of the first phase-cycling pattern for the first transmit antenna and the first subsequence of the set of multiple subsequences with a second phase of the second phase-cycling pattern for the second transmit antenna, where the first phase may be different from the second phase.

Some examples of the method, apparatuses, and non-transitory computer-readable medium described herein may further include operations, features, means, or instructions for applying the first phase-cycling pattern to a first bit of the modulated sample sequence and the second phase-cycling pattern to the first bit of the modulated sample sequence.

Some examples of the method, apparatuses, and non-transitory computer-readable medium described herein may further include operations, features, means, or instructions for converting the first phase-cycling modulated sample sequence to a first orthogonal frequency division multiplexing (OFDM) waveform and the second phase-cycling modulated sample sequence to a second OFDM waveform, where the first signal may be generated based on the first OFDM waveform and the second signal may be generated based on the second OFDM waveform.

In some examples of the method, apparatuses, and non-transitory computer-readable medium described herein, the first OFDM waveform and the second OFDM waveform may be mapped to resources corresponding to a single OFDM symbol.

In some examples of the method, apparatuses, and non-transitory computer-readable medium described herein, the first OFDM waveform and the second OFDM waveform may be mapped to resources corresponding to a set of multiple OFDM symbols.

In some examples of the method, apparatuses, and non-transitory computer-readable medium described herein, the first signal and the second signal may be associated with a zero mean.

In some examples of the method, apparatuses, and non-transitory computer-readable medium described herein, the first phase-cycling modulated sample sequence and the second phase-cycling modulated sample sequence may be each associated with a zero mean.

In some examples of the method, apparatuses, and non-transitory computer-readable medium described herein, the first signal and the second signal include low-power synchronization signals, low-power preamble signals, low-power wake-up signals, or any combination thereof.

In some examples of the method, apparatuses, and non-transitory computer-readable medium described herein, the modulated sample sequence includes an on-off keying (OOK) sample sequence, an amplitude-shift keying (ASK) sample sequence, or a frequency-shift keying (FSK) sample sequence.

A method for wireless communication at a transmitter is described. The method may include modulating one or more bits into a modulated sample sequence for wireless transmission to a receiver, generating, in accordance with a transmission staggering pattern, a first signal from the modulated sample sequence for transmission via a first transmit antenna and a second signal from the modulated sample sequence for transmission via a second transmit antenna, and transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern.

An apparatus for wireless communication at a transmitter is described. The apparatus may include a processor, memory coupled with the processor, and instructions stored in the memory. The instructions may be executable by the processor to cause the apparatus to modulate one or more bits into a modulated sample sequence for wireless transmission to a receiver, generating, in accordance with a transmission staggering pattern, a first signal from the modulate sample sequence for transmission via a first transmit antenna and a second signal from the modulated sample sequence for transmission via a second transmit antenna, and transmit the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern.

Another apparatus for wireless communication at a transmitter is described. The apparatus may include means for modulating one or more bits into a modulated sample sequence for wireless transmission to a receiver, means for generating, in accordance with a transmission staggering pattern, a first signal from the modulated sample sequence for transmission via a first transmit antenna and a second signal from the modulated sample sequence for transmission via a second transmit antenna, and means for transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern.

A non-transitory computer-readable medium storing code for wireless communication at a transmitter is described. The code may include instructions executable by a processor to modulate one or more bits into a modulated sample sequence for wireless transmission to a receiver, generating, in accordance with a transmission staggering pattern, a first signal from the modulate sample sequence for transmission via a first transmit antenna and a second signal from the modulated sample sequence for transmission via a second transmit antenna, and transmit the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern.

In some examples of the method, apparatuses, and non-transitory computer-readable medium described herein, the transmission staggering pattern indicates to stagger the transmission of the first signal and the second signal across different frequency subbands of a resource allocation.

In some examples of the method, apparatuses, and non-transitory computer-readable medium described herein, transmitting the first signal and the second signal may include operations, features, means, or instructions for transmitting the first signal during a first portion of an on-duration of the modulated sample sequence and the second signal during a second portion of the on-duration of the modulated sample sequence, where the first portion and the second portion of the on-duration occur at the non-overlapping times in accordance with the transmission staggering pattern.

In some examples of the method, apparatuses, and non-transitory computer-readable medium described herein, a first transmission power level associated with the first signal during the first portion of the on-duration may be equal to a second transmission power level associated with the second signal during the second portion of the on-duration.

In some examples of the method, apparatuses, and non-transitory computer-readable medium described herein, transmitting the first signal and the second signal may include operations, features, means, or instructions for transmitting the first signal that may be a first interlace during a first portion of an on-duration of the modulated sample sequence and the second signal that may be a second interlace during a second portion of the on-duration of the modulated sample sequence, where the first interlace and the second interlace may be non-overlapping in time in accordance with the transmission staggering pattern.

Some examples of the method, apparatuses, and non-transitory computer-readable medium described herein may further include operations, features, means, or instructions for transmitting the first signal via the first transmit antenna in a first subband of an allocated bandwidth and the second signal via the second transmit antenna using a second subband of the allocated bandwidth, where the first subband may be different from the second subband.

In some examples of the method, apparatuses, and non-transitory computer-readable medium described herein, generating the first signal and the second signal may include operations, features, means, or instructions for generating, in accordance with the transmission staggering pattern that indicates to apply a phase ramp in a frequency domain, the first signal and the second signal.

Some examples of the method, apparatuses, and non-transitory computer-readable medium described herein may further include operations, features, means, or instructions for converting a first staggered modulated sample sequence to a first OFDM waveform and a second staggered modulated sample sequence to a second OFDM waveform, where the first signal may be generated based on the first OFDM waveform and the second signal may be generated based on the second OFDM waveform.

In some examples of the method, apparatuses, and non-transitory computer-readable medium described herein, the first OFDM waveform and the second OFDM waveform may be mapped to resources corresponding to a single OFDM symbol.

In some examples of the method, apparatuses, and non-transitory computer-readable medium described herein, the first OFDM waveform and the second OFDM waveform may be mapped to resources corresponding to a set of multiple OFDM symbols.

In some examples of the method, apparatuses, and non-transitory computer-readable medium described herein, the first signal and the second signal include low-power synchronization signals, low-power preamble signals, low-power wake-up signals, or any combination thereof.

In some examples of the method, apparatuses, and non-transitory computer-readable medium described herein, the modulated sample sequence includes an OOK sample sequence, an ASK sample sequence, or an FSK sample sequence.

### BRIEF DESCRIPTION OF THE DRAWINGS

FIG. 1 illustrates an example of a wireless communications system that supports spatial diversity for low-power wake-up signals in accordance with one or more aspects of the present disclosure.

FIG. 2 illustrates an example of a phase-cycling scheme that supports spatial diversity for low-power wake-up signals in accordance with one or more aspects of the present disclosure.

FIGS. 3 through 5 illustrate examples of transmission staggering schemes that support spatial diversity for low-power wake-up signals in accordance with one or more aspects of the present disclosure.

FIGS. 6 and 7 illustrate examples of process flows that support spatial diversity for low-power wake-up signals in accordance with one or more aspects of the present disclosure.

FIGS. 8 and 9 illustrate block diagrams of devices that support spatial diversity for low-power wake-up signals in accordance with one or more aspects of the present disclosure.

FIG. 10 illustrates a block diagram of a communications manager that supports spatial diversity for low-power wake-up signals in accordance with one or more aspects of the present disclosure.

FIG. 11 illustrates a diagram of a system including a device that supports spatial diversity for low-power wake-up signals in accordance with one or more aspects of the present disclosure.

FIGS. 12 through 17 illustrate flowcharts showing methods that support spatial diversity for low-power wake-up signals in accordance with one or more aspects of the present disclosure.

### DETAILED DESCRIPTION

In some wireless communications systems, wireless devices may transmit and receive low-power wake-up signals. To reduce power consumption when receiving low-power wake-up signals, a transmitter may use a waveform that may reduce complicated baseband processing. For example, the transmitter may use amplitude-shift keying (ASK), frequency-shift keying (FSK), or on-off keying (OOK) to modulate a low-power wake-up signal, which a receive may demodulate with filters and envelop detection. For these modulation schemes, the receiver (which may be a low-power receiver) may recover the amplitude of the signal, however may lose the phase of the signal. Additionally, the receiver may be equipped with one receive antenna instead of multiple. These conditions may limit the receiver from achieving a same coverage as for other New Radio (NR) signals (e.g., a physical downlink control channel (PDCCH)) that are received by a primary (e.g., main) radio with multiple receive antennas and using complicated baseband or coherent processing.

Techniques, systems, and devices described herein support spatial diversity for ASK, FSK, or OOK-based low-power wake-up signals. In some cases, to create such spatial diversity when a receiver (e.g., a low-power receiver, a user equipment (UE)) uses one receive antenna and a transmitter (e.g., a network node) uses multiple transmit antennas, the transmitter may generate signals using a phase-cycling pattern or a transmission staggering pattern. The transmitter may modulate one or more bits into a modulated sample sequence and apply phase-cycling patterns to subsequences of the modulated sample sequence to generate respective phase-cycling modulated sample sequences. The transmitter may transmit signals via respective antennas based on the phase-cycling modulated sample sequences, which the receiver may receive and decode via a single receive antenna.

Alternatively, after modulating the bits into the modulated sample sequence, the transmitter may generate multiple signals from the modulated sample sequence and in accordance with a transmission staggering pattern, which may indicate to stagger transmission of the signals across different frequency subbands. The transmitter may transmit the signals via respective antennas and at non-overlapping times or frequencies in accordance with the transmission staggering pattern. In this way, the transmitter may create spatial diversity by transmitting the signals via separate antennas according to the phase-cycling pattern or the transmission staggering pattern, which may enable the receiver to operate at a low-power and receive the signals via a single antenna (e.g., using envelop detection).

Aspects of the disclosure are initially described in the context of wireless communications systems. Aspects of the disclosure are then described in the context of phase-cycling schemes, transmission staggering schemes, and process flows. Aspects of the disclosure are further illustrated by and described with reference to apparatus diagrams, system diagrams, and flowcharts that relate to spatial diversity for low-power wake-up signals.

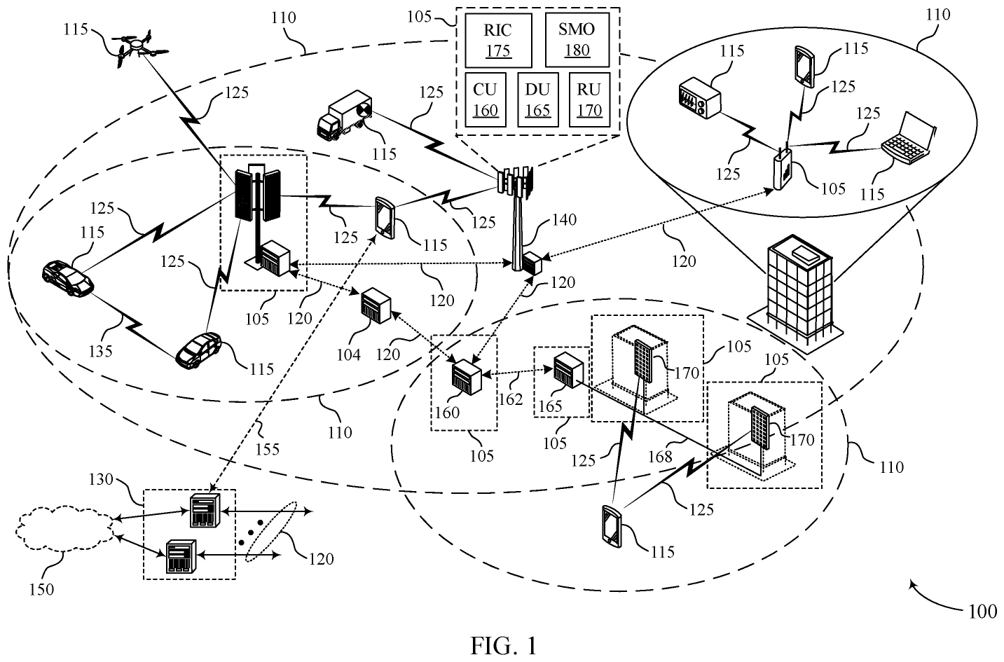

FIG. 1 illustrates an example of a wireless communications system 100 that supports spatial diversity for low-power wake-up signals in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 (e.g., a network node 105) may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support spatial diversity for low-power wake-up signals as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some cases, the wireless communication system 100 may support zero or near-zero-power wireless devices (e.g., receivers, transmitters), as well as other lower power devices. To reduce power consumption of a receiver, the wireless communications system 100 may support ASK-based, FSK-based signals, OOK-based signals, or any combination thereof. A receiver may use filters or envelop detection when receiving such signals, which may reduce its power consumption over other forms of signal detection (e.g., coherent detection). For example, a network node 105 (e.g., a transmitter) may transmit a low-power wake-up signal to a UE 115 (e.g., a receiver), and the UE 115 may receive the signal using just a low-power wake-up radio instead of a main radio (while the main radio is in a sleep mode). Based on receiving the low-power wake-up signal, the UE 115 may wake-up the main radio and use it to receive other, higher-powered signals.

A transmitter may design a signal waveform that is receivable by a receiver using the low-power wake-up radio. Such waveforms may include ASK, FSK, and OOK-based waveforms, which the receiver may demodulate using simple filters and envelop detectors. Thus, the receiver may demodulate low-power wake-up signals using reduced power. However, because this receiver design is limited, the receiver may lack the same sensitivity or coverage when using the low-power wake-up radio (which may include a single antenna) as when using the main radio (which may include multiple antennas). That is, the more complex the receiver is, the more sensitivity it may have, where the sensitivity may refer to a minimum amount of receive power required for the receiver to function. For example, the low-power wake-up radio may work at a −80 dBm power, and the main radio may work at a −100 dBm power.

In some examples, a transmitter may generate cyclic prefix-OFDM compatible OOK signals (or other modulated signals). The signals may be placed in an OFDM time and frequency grid and have limited bandwidths to a set of subcarriers allocated for OFDM (without generating interference for other non-OOK signals). In this way, the transmitter may generate an oversampled OOK signal and post-process the signal such that it may be placed in the OFDM time and frequency grid. By oversampling the OOK signal, the data rate for the OOK signal may be smaller than an actual sampling rate and bandwidth of a transmitted signal. That is, the transmitter may transmit a low-power wake-up signal well below a Nyquist rate. For example, a low-power wake-up signal may work with a 4 MHz bandwidth at a data rate of approximately 100,000 bits per second.

In some examples, when receiving a low-power wake-up signal, a receiver (e.g., a UE 115) may use low-power and one receive antenna (with simple hardware). To ensure that the coverage of such a low-power receiver matches that of a regular, higher-powered receiver, the transmitter (e.g., a network node 105) may use its multiple transmit antennas to create spatial diversity. Instead of using spatial diversity techniques such as space-time coding, Alamouti code, space-time block coding (STBC), or space-frequency block coding (SFBC), among other spatial diversity techniques (which may not apply to a low-power wake-up radio which may fail to obtain phase information), the transmitter may use intra-symbol beam sweeping and precoder cycling or staggered transmissions.

The wireless communications system 100 supports phase-cycling patterns and transmission staggering patterns for generating low-power signals. To create spatial diversity when a receiver (e.g., a low-power receiver, a UE 115) uses one receive antenna and a transmitter (e.g., a network node 105) uses multiple transmit antennas, the transmitter may generate signals using a phase-cycling pattern or a transmission staggering pattern. In some aspects, transmitter may modulate one or more bits into a modulated sample sequence and apply phase-cycling patterns to subsequences of the modulated sample sequence to generate respective phase-cycling modulated sample sequences. The transmitter may transmit signals via respective antennas based on the phase-cycling modulated sample sequences, which the receiver may receive and decode via a single receive antenna. Alternatively, after modulating the bits into the modulated sample sequence, the transmitter may generate multiple signals from the modulated sample sequence and in accordance with a transmission staggering pattern, which may indicate to stagger transmission of the signals across different frequency subbands. The transmitter may transmit the signals via respective antennas and at non-overlapping times or frequencies in accordance with the transmission staggering pattern. In this way, the transmitter may create spatial diversity by transmitting the signals via separate antennas according to the phase-cycling pattern or the transmission staggering pattern, which may enable the receiver to operate at a low-power and receive the signals via a single antenna (e.g., using envelop detection).

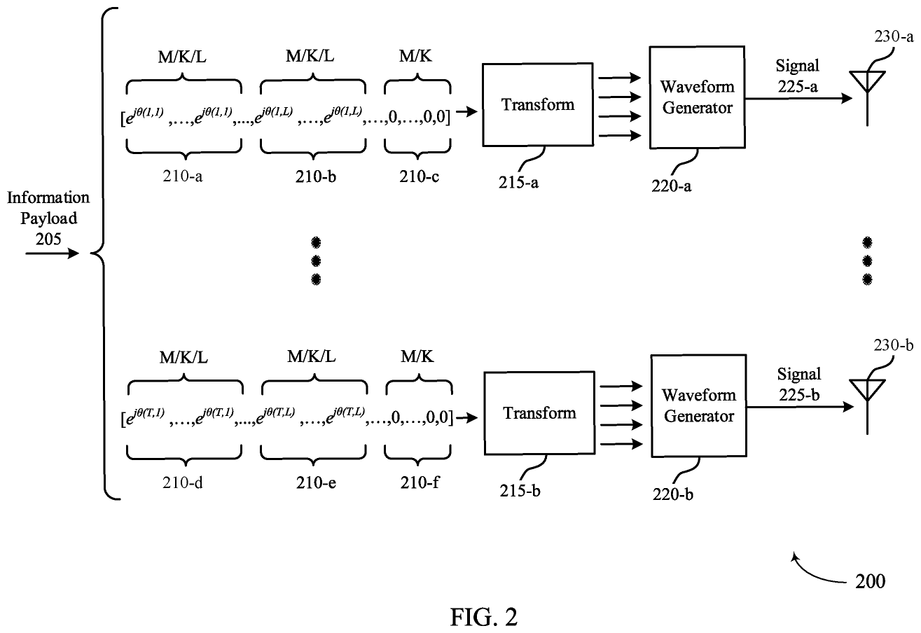

FIG. 2 illustrates an example of a phase-cycling scheme 200 that supports spatial diversity for low-power wake-up signals in accordance with one or more aspects of the present disclosure. In some examples, the phase-cycling scheme 200 may implement aspects of the wireless communications system 100 or may be implemented by aspects of the wireless communications system 100. For example, a transmitter (e.g., a wireless communication device such as a network node) may use the phase-cycling scheme 200 to generate signals 225 for transmission to a receiver (e.g., a wireless communication device such as a UE). In some examples, the transmitter may use the phase-cycling scheme 200 for cases in which the transmitter uses multiple antennas 230 to transmit low-power signals (e.g., low-power wake-up signals) to the receiver, and the receiver receives the signals using a single antenna.

A wireless communications system may support communications between the transmitter and the receiver, which may include communication of low-power wake-up signals and other low-power signals. In some examples, the transmitter may support two or more antennas, including an antenna 230-a (e.g., Tx antenna 1) and an antenna 230-b (e.g., Tx antenna T, where T may represent the total quantity of transmit antennas). As the receiver may be equipped with a single receive antenna, the transmitter may use a phase-cycling pattern associated with the phase cycling scheme 200 to design specific signals for transmission to the receiver such that the receiver may utilize the different channels associated with the multiple antennas 230.

In some aspects, the transmitter may receive an information payload 205 including one or more bits (e.g., 1s and 0s). The transmitter may modulate one or more bits into a modulated sample sequence for wireless transmission to the receiver via an antenna 230. The modulated sample sequence may be an OOK-modulated sample sequence, an ASK-modulated sample sequence, an FSK-modulated sample sequence, or any other low-complexity modulation-based sample sequence.

The transmitter may use intra-symbol beam sweeping or precoder cycling to generate signals for transmission via the antennas 230 with spatial diversity. Within each over-sampled time-domain modulated (e.g., OOK) symbol of the modulated sample sequence within an ON duration, the transmitter may multiply a time-domain signal (represented as “x” within the modulated sample sequence) with a corresponding phase sequence on each of the antennas 230 corresponding to the same OOK symbol. For example, the modulated sample sequence may have a length of M/K that is further divided into L subsequences 210 (also referred to herein as sample groups), such that each subsequence 210 may include M/K/L samples, and each sample (e.g., including “x” values) is multiplied by a phase. M may represent an integer multiple of K such that each ON-OFF duration of the modulated sample sequence is a same length.

The transmitter may apply a first phase-cycling pattern which includes a set of phases to the subsequences 210 of the modulated sample sequence to generate a first phase-cycling modulated sample sequence for transmission via the antenna 230-a (e.g., a first antenna). Additionally, the transmitter may apply a second phase-cycling pattern which includes a set of phases to the subsequences 210 of the modulated sample sequence to generate a second phase-cycling modulated sample sequence for transmission via the antenna 230-b (e.g., a second antenna). For example, the first phase-cycling pattern may include the phases e^{jθ}^{_{1,1}}, e^{jθ}^{_{1,2}}, . . . , e^{jθ}^{_{1,L}} that are respectively applied to the subsequences 210 corresponding to the antenna 230-a (e.g., multiply a respective subsequence by a respective phase), and the second phase-cycling pattern may include the phases e^{jθ}^{_{T,1}}, e^{jθ}^{_{T,2}}, . . . , e^{jθ}^{_{T,L}} applied to the subsequences 210 corresponding to the antenna 230-b. The transmitter may apply respective phase-cycling modulated sample sequences for any number of antennas 230 used by the transmitter (e.g., two or more antennas).

In some cases, the transmitter may multiply a subsequence 210-a (e.g., a first subsequence of values “x”) with a first phase of the first phase-cycling pattern for the antenna 230-a, and a subsequence 210-d (e.g., the same, first subsequence of values “x”) with a second phase of the second phase-cycling pattern for the antenna 230-b, where the first and second phases differ. This may repeat for each subsequence 210 of the modulated sample sequence generated for each antenna 230. In this way, the transmitter may multiply the transmitted time-domain signal (e.g., the modulated sample sequence) with a corresponding phase sequence on each antenna 230 corresponding to the same modulated (e.g., OOK) symbol.

The transmitter may use a different phase for each subsequence 210 (e.g., sample group) or in some cases, each sample of a modulated symbol on each antenna 230. For example, the transmitter may multiply a phase e^{jθ}^{_{1,1}} with the M/K/L samples of the subsequence 210-a and a phase e^{jθ}^{_{1,L}} with the M/K/L samples of a subsequence 210-b for transmission to the receiver via the antenna 230-a, where the subsequence 210-a and the subsequence 210-b may include ON symbols (e.g., an ON duration of the first phase-cycling modulated sample sequence). A subsequence 210-c may be an OFF duration of the first phase-cycling modulated sample sequence, and as such may include M/K zero samples. Additionally, the transmitter may multiply a phase e^{jθ}^{_{T,1}} with the M/K/L samples of the subsequence 210-d and a phase e^{jθ}^{_{T,L}} with the M/K/L samples of a subsequence 210-e for transmission to the receiver via the antenna 230-b, where the subsequence 210-d and the subsequence 210-e may include ON symbols (e.g., an ON duration of the second phase-cycling modulated sample sequence). A subsequence 210-f may be an OFF duration of the second phase-cycling modulated sample sequence, and as such may include M/K zero bits.

The transmitter may apply the phase sequences for one modulated bit within an ON duration of a modulated symbol of a subsequence 210. For example, the subsequence 210-a and the subsequence 210-b, which may be in an ON duration of the first phase-cycling modulated sample sequence for the antenna 230-a, may be included in one same bit, and likewise the subsequence 210-d and the subsequence 210-e may be included in a same one bit of an ON duration of the second phase-cycling modulated sample sequence. That is, the transmitter may apply the first phase-cycling pattern to a first bit of the modulated sample sequence and the second phase-cycling pattern to the first bit of the modulated sample sequence for the antenna 230-a and the antenna 230-b, respectively.

Additionally, within a same ON duration of a modulated symbol, the transmitter may apply different precodings (e.g., different phases) to the modulated sample sequence for transmission via the antennas 230. For example, the phase e^{jθ}^{_{1,1}} (applied to the subsequence 210-a for the antenna 230-a) and the phase e^{jθ}^{_{T,1}} (applied to the subsequence 210-d for the antenna 230-b) may correspond to a same precoder, such that the precoder applies to multiple antennas 230. In performing precoding cycling, the transmitter may cycle across different precoders across different subsequences 210. In this way, a second precoder may include the phase e^{jθ}^{_{1,L}} (applied to the subsequence 210-b for the antenna 230-a) and the phase e^{jθ}^{_{T,L}} (applied to the subsequence 210-e for the antenna 230-b). Moreover, the each precoder may correspond to a generated beam, such that the transmitter may transmit each of the L subsequences 210 in beams of slightly different directions.

The transmitter may transmit the signal 225-a via the antenna 230-a based on the first phase-cycling modulated sample sequence, and the signal 225-b via the antenna 230-b based on the second phase-cycling modulated sample sequence. In some examples, to generate the signals 225, the transmitter may convert each phase-cycling modulated sample sequence to an OFDM waveform using a respective transform 215 and a respective waveform generator 220. In an example, the waveform generator 220 may perform an N point inverse fast Fourier transform (iFFT) algorithm on the output of transform 215 to generate an OFDM waveform or may be another type of OFDM waveform generator. In an example, the transmitter may convert the first phase-cycling modulated sample sequence to a first OFDM waveform using a waveform generator 220-a and the second phase-cycling modulated sample sequence to a second OFDM waveform using a waveform generator 220-b, where the signal 225-a is generated based on the first OFDM waveform and the signal 225-b is generated based on the second OFDM waveform.

In converting the phase-cycling modulated sample sequences to OFDM waveforms, the transmitter may apply respective transforms 215 (e.g., a transform 215-a for the antenna 230-a and a transform 215-b for the antenna 230-b) to the phase-cycling modulated sample sequences. In doing so, the transmitter may convert the time-domain signal to the frequency domain such the first and second OFDM waveforms are mapped to resources corresponding to one or multiple OFDM symbols. In some cases, the transforms 215 may change the time-domain samples into the frequency domain such that they are mapped to a set of resource elements or resource blocks associated with the transmission of the signals 225 (e.g., OOK transmissions). In some cases, the transforms 215 may be M-point DFTs such that the OFDM waveforms may be DFT-S-OFDM-based modulated signals.

Additionally, the signals 225 may be low-power synchronization signals, low-power preamble signals, low-power wake-up signals, or any other low-power signal. The transmitter may transmit a low-power synchronization signal, a low-power preamble signal, a low-power wake-up signal, or any combination thereof via separate channels, or the transmitter may transmit the low-power synchronization signal and the low-power preamble signal prior to each low-power wake-up signal transmission. The receiver may use the low-power synchronization signal, the low-power preamble signal, or both to perform time or frequency synchronization with the transmitter and to train AGC of the receiver. As such, the low-power synchronization signal, the low-power preamble signal, or both may have a same dynamic range as the low-power wake-up signal, for example a same precoder cycling or a same transmission staggering pattern.

In an example, the transmitter may modulate the modulated sample sequence for transmission to the receiver via the antenna 230-a and the antenna 230-b (e.g., a quantity of transmit antennas may be T=2), where a quantity of phase values is equal to L=4 (e.g., the subsequence 210-a, the subsequence 210-b, the subsequence 210-d, and the subsequence 210-e). The transmitter may apply a phase pattern represented as a matrix

$$\begin{matrix}1 & 1 & 1 & 1 \\ 1 & j & - 1 & - j\end{matrix}$$

to the subsequences 210, where j may represent a ninety-degree phase shift. Each row of the matrix may represent an antenna 230 and each column of the matrix may represent a precoder to be applied to each subsequence 210. As such, the transmitter may refrain from phase shifting the samples transmitted via the antenna 230-a, and may phase shift every quarter of the transmitted samples on the antenna 230-b by ninety degrees.

In another example, the transmitter may use a subset of DFT matrices as the phase-cycling patterns applied for the antennas 230. In such cases, the transmitter may apply a first DFT matrix to the first phase-cycling modulated sample sequence to generate a first DFT sequence, and a second DFT matrix to the second phase-cycling modulated sample sequence to generate a second DFT sequence. The transmitter may then generate the signal 225-a and the signal 225-b based on the first and second DFT sequences, respectively. A DFT matrix may be represented as

$$\begin{matrix}1 & {e}^{- 0 \cdot \frac{j 2 π {q}_{1}}{Q}} & … & {e}^{- 0 \cdot \frac{j 2 π ( L - 1 ) {q}_{L - 1}}{Q}} \\ 1 & {e}^{- 0 \cdot \frac{j 2 π ( T - 1 ) {q}_{1}}{Q}} & … & {e}^{- 0 \cdot \frac{j 2 π ( T - 1 ) {q}_{L - 1}}{Q}}\end{matrix} ,$$

where Q, q₁, . . . , q_{L-1} may represent integers. Each row of the DFT matrix may represent an antenna 230, and each column of the DFT matrix may denote a beam pattern, such that the transmitter may apply beam sweeping or precoder cycling inside each modulated symbol.

In some cases, the transmitter may generate the signals 225 on respective antennas 230 such that the overall signal has a zero mean in the time domain, for example to avoid transmitting signals as a direct current (DC) tone. As such, the transmitter may select a sequence (e.g., x, x, x, x) used to populate the ON duration of the modulated sample sequence such that after multiplying the sequence with the phase-cycling pattern, the overall signal has a zero mean (e.g., a summation of the OOK samples in the ON duration is equal to zero). In this way, the signal 225-a and the signal 225-b may be associated with a zero mean and the first phase-cycling modulated sample sequence and the second phase-cycling modulated sample sequence may each be associated with a zero mean. In having the transmitted signal to have a zero mean may avoid any transmissions on the DC tone, hence reducing DC leakage. Alternatively, the transmitter may explicitly remove the signals on the DC tone before transmitting the signal over the air. That is, the transmitter may compute a mean of the sequences (e.g., phase-cycled sequences) and subtract the mean from the signal to make the signal zero-mean, hence having empty power at the DC tone.

Spatial diversity, as described herein, may refer to using multiple wireless communication links to connect the transmitter and the receiver such that the transmitter and receiver may communicate over multiple channels. As long as at least one of the channels is usable (e.g., lacks high traffic and interference), the transmitter and the receiver may communicate successfully. If the receiver has four receive antennas, the receiver may receive four copies of a message from the transmitter to achieve spatial diversity. However, if the receiver (e.g., a low-power receiver using a low-power wake-up radio) has a single receive antenna, the receiver may receive messages transmitted at the same time on a same resource, limiting the receiver's decoding abilities as there is a lack of spatial diversity in the transmission. Accordingly, the transmitter may use the techniques described herein to create spatial diversity using its multiple transmit antennas when the receiver uses a single receive antenna.

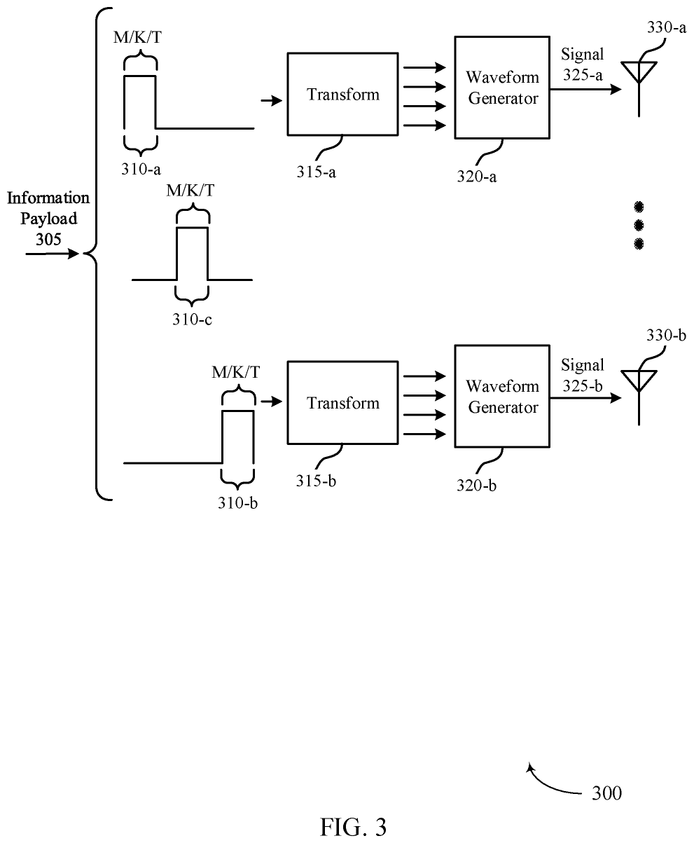

FIG. 3 illustrates an example of a transmission staggering scheme 300 that supports spatial diversity for low-power wake-up signals in accordance with one or more aspects of the present disclosure. In some examples, the transmission staggering scheme 300 may implement aspects of the wireless communications system 100 or may be implemented by aspects of the wireless communications system 100. For example, a transmitter (e.g., a wireless communication device such as a network node) may use the transmission staggering scheme 300 to generate signals 325 for transmission to a receiver (e.g., a wireless communication device such as a UE). In some examples, the transmitter may use the transmission staggering scheme 300 for cases in which the transmitter uses multiple antennas 330 to transmit low-power signals (e.g., low-power wake-up signals) to the receiver, and the receiver receives the signals using a single antenna.

A wireless communications system may support communications between the transmitter and the receiver, which may include communication of low-power wake-up signals and other low-power signals. In some examples, the transmitter may support two or more antennas, including an antenna 330-a (e.g., Tx antenna 1) and an antenna 330-b (e.g., Tx antenna T, where T may represent the total quantity of transmit antennas). As the receiver may be equipped with a single receive antenna, the transmitter may use the transmission staggering to design specific signals for transmission to the receiver such that the receiver may utilize the different channels associated with the multiple antennas 330.

In some aspects, the transmitter may receive an information payload 305 including one or more bits (e.g., 1s and 0s). The transmitter may modulate the one or more bits into a modulated sample sequence for wireless transmission to the receiver via the antennas 330. The modulated sample sequence may be an OOK-modulated sample sequence, an ASK-modulated sample sequence, an FSK-modulated sample sequence, or any other low-complexity modulation-based sample sequence. In addition, the modulated sample sequence, which may also be referred to as a time-domain signal, may have a length of M/K samples, where M is an integer multiple of K such that each ON-OFF duration of the modulated sample sequence is a same length. The transmitter may divide the M/K samples by T, where T may represent a total quantity of antennas 330 (e.g., 2 or more antennas). As such, the transmitter may generate modulated (e.g., samples) for the modulated sample sequence that includes an ON duration 310-a, an ON duration 310-b, and an ON duration 310-c. Each ON duration may include a quantity M/K/T samples of the modulated sample sequence, such that the ON durations 310 are all portions of a same ON duration period of the modulated sample sequence.

In addition, the transmitter may generate the samples such that the ON durations 310 are staggered when transmitted via different antennas 330. Within each ON symbol of an over-sampled time-domain modulated symbol (e.g., the M/K symbols), the transmitter may transmit a shortened ON duration (e.g., the ON durations 310) of the modulated sample sequence with different staggering via each antenna 330, where an ON duration 310 may have a length that is 1/T the length of a conventional ON duration for the modulated sample sequence. That is, the transmitter may generate, in accordance with a transmission staggering pattern, a signal 325-a (e.g., a first signal) from the modulated sample sequence for transmission via the antenna 330-a and a signal 325-b (e.g., a second signal) from the modulated sample sequence for transmission via the antenna 330-b. The transmitter may transmit the signal 325-a during the ON duration 310-a, and the signal 325-b during the ON duration 310-b. The ON duration 310-c may include no data or may be transmitted via another antenna 330.

The transmitter may stagger transmissions of the signals 325 in the time domain such that only one antenna 330 is on and in use at a given time. The transmitter may transmit the signal 325-a via the antenna 330-a and the signal 325-b via the antenna 330-b, where the signals 325 are transmitted via the respective antennas 330 at non-overlapping times or non-overlapping frequencies in accordance with the transmission staggering pattern. For example, the ON durations 310 may be at offset (e.g., different, non-overlapping) times. In some cases, the transmitter may transmit the signal 325-a during a first portion of the ON duration of the modulated sample sequence (e.g., the ON duration 310-a) and the signal 325-b during a second portion of the ON duration of the modulated sample sequence (e.g., the ON duration 310-b), where the first and second portions of the ON duration occur at non-overlapping times in accordance with the transmission staggering pattern.

Because the signals 325 are transmitted in respective portions of an ON duration, a first transmission power level associated with the signal 325-a during the ON duration 310-a may be equal to a second transmission power level associated with the second signal during the ON duration 310-b. That is, the ON durations 310 being portions of a same ON duration period and being staggered in time (resulting in one antenna 330 being activated at a given time) may increase the power of a signal transmission and simplify envelop detection at the receiver.

In some cases, the transmitter may configure each signal 325 to be transmitted separately on respective antennas 330 in the time domain or in a frequency domain. When a time-domain cyclic shift is equivalent to a frequency-domain phase ramp, the transmitter may implement the transmission staggering pattern in the frequency domain as different phase ramps. That is, the transmission staggering pattern may indicate to stagger the transmission of the signal 325-a and the signal 325-b across different frequency subbands of a resource allocation. The transmitter may generate, in accordance with the transmission staggering pattern that indicates to apply a phase ramp in a frequency domain, the first signal and the second signal.

In some examples, to generate the signals 325, the transmitter may convert each staggered modulated sample sequence (e.g., transmitted in the ON durations 310) to an OFDM waveform using a respective transform 315 and a respective waveform generator 320. For example, the transmitter may convert the first staggered modulated sample sequence to a first OFDM waveform using a waveform generator 320-a and the second staggered modulated sample sequence to a second OFDM waveform using a waveform generator 320-b, where the signal 325-a is generated based on the first OFDM waveform and the signal 325-b is generated based on the second OFDM waveform. In an example, the waveform generator 320 may perform an N point inverse fast Fourier transform (iFFT) algorithm on the output of transform 315 to generate an OFDM waveform or may be another type of OFDM waveform generator.

In converting the staggered modulated sample sequences to OFDM waveforms, the transmitter may apply respective transforms 315 (e.g., a transform 315-a for the antenna 330-a and a transform 315-b for the antenna 330-b) to the phase-cycling modulated sample sequences. In doing so, the transmitter may convert the time-domain signal to the frequency domain such the first and second OFDM waveforms are mapped to resources corresponding to one or multiple OFDM symbols. In some cases, the transforms 315 may be M-point DFTs such that the OFDM waveforms may be DFT-S-OFDM-based modulated signals.

By applying spatial diversity to communications with a receiver as described herein within a modulated symbol, the receiver may use an envelope detector to demodulate the signals 325. That is, while the receiver may receive the signals 325 from multiple antennas 330, the receiver may detect an overall signal across the multiple antennas 330 to detect and demodulate the transmission. As such, the receiver's power consumption may be the same for such cases of relatively high spatial diversity as when the transmitter communicates with low spatial diversity.

Additionally, the signals 325 may be low-power synchronization signals, low-power preamble signals, low-power wake-up signals, or any other low-power signal. The transmitter may transmit a low-power synchronization signal, a low-power preamble signal, a low-power wake-up signal, or any combination thereof via separate channels, or the transmitter may transmit the low-power synchronization signal and the low-power preamble signal prior to each low-power wake-up signal transmission. The receiver may use the low-power synchronization signal, the low-power preamble signal, or both to perform time or frequency synchronization with the transmitter and to train AGC of the receiver. As such, the low-power synchronization signal, the low-power preamble signal, or both may have a same dynamic range as the low-power wake-up signal, for example a same precoder cycling or a same transmission staggering pattern.

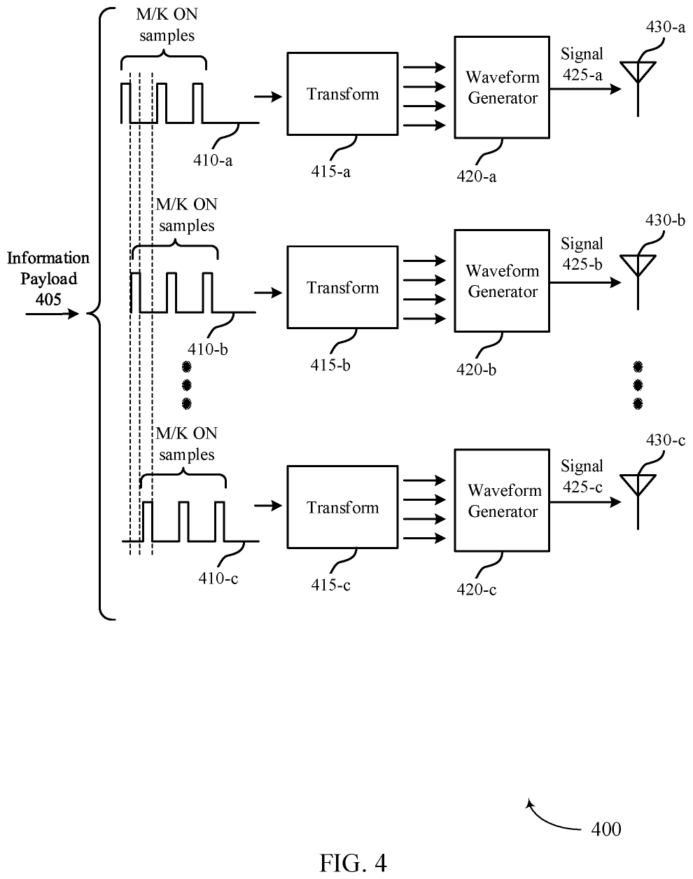

FIG. 4 illustrates an example of a transmission staggering scheme 400 that supports spatial diversity for low-power wake-up signals in accordance with one or more aspects of the present disclosure. In some examples, the transmission staggering scheme 400 may implement aspects of the wireless communications system 100 or may be implemented by aspects of the wireless communications system 100. For example, a transmitter (e.g., a wireless communication device such as a network node) may use the transmission staggering scheme 400 to generate signals 425 for transmission to a receiver (e.g., a wireless communication device such as a UE). In some examples, the transmitter may use the transmission staggering scheme 400 for cases in which the transmitter uses multiple antennas 430 to transmit low-power signals (e.g., low-power wake-up signals) to the receiver, and the receiver receives the signals using a single antenna.

A wireless communications system may support communications between the transmitter and the receiver, which may include communication of low-power wake-up signals and other low-power signals. In some examples, the transmitter may support two or more antennas, including an antenna 430-a (e.g., Tx antenna 1) and an antenna 430-b (e.g., Tx antenna T, where T may represent the total quantity of transmit antennas). As the receiver may be equipped with a single receive antenna, the transmitter may use the transmission staggering to design specific signals for transmission to the receiver such that the receiver may utilize the different channels associated with the multiple antennas 430.

In some aspects, the transmitter may receive an information payload 405 including one or more bits (e.g., 1s and 0s). The transmitter may modulate the one or more bits into a modulated sample sequence for wireless transmission to the receiver via the antennas 430. The modulated sample sequence may be an OOK-modulated sample sequence, an ASK-modulated sample sequence, an FSK-modulated sample sequence, or any other low-complexity modulation-based sample sequence. In addition, the modulated sample sequence, which may also be referred to as a time-domain signal, may have a length of M/K samples, where M is an integer multiple of K such that each ON-OFF duration of the modulated sample sequence is a same length. The transmitter may generate a subsequence 410-a, a subsequence 410-b, and a subsequence 410-c from the modulated sample sequence, where each subsequence 410 includes M/K samples in its ON durations.

In addition, the transmitter may generate the subsequences 410 such that corresponding ON durations are staggered (e.g., the subsequences 410 may also be referred to herein as staggered modulated sample sequences). The transmitter may partition the ON durations into several interlaces, where each antenna 430 may use one interlace to transmit at a transmit power level (e.g., an on-power) while the other antennas 430 may be in an off or sleep mode. As described herein, an interlace may refer to a series of ON and OFF durations of a modulated sequence (such as the subsequences 410), where ON duration corresponding to one antenna 430 may be nonoverlapping with any ON durations corresponding to different antennas 430. That is, the interlaces of the ON durations for the subsequences 410 may be non-overlapping in time, and the transmitter may transmit the signals 425 (generated from the subsequences 410) via different antennas 430 using the transmission staggering pattern or some cyclic shift pattern over time.

The transmitter may transmit the signal 425-a (e.g., a first signal) that is a first interlace during a first portion of an ON duration of the modulated sample sequence via the antenna 430-a and the signal 425-b (e.g., a second signal) that is a second interlace during a second portion of the ON duration of the modulated sample sequence via the antenna 430-b, where the first interlace and the second interlace are non-overlapping in time in accordance with the transmission staggering pattern. In some cases, the transmitter may use a quantity T interlaces for transmitting T signals 425 via T corresponding antennas 430. For example, the transmitter may transmit a signal 425-c (e.g., a Tth signal) that is a Tth interlace during a Tth partition of the ON duration via an antenna 430-c, and where the Tth interlace may be non-overlapping with the first and second interlaces.

When transmitted, the signals 425 may have different sequences of ON and OFF durations that are non-overlapping based on the interlaces, such that one antenna 430 may be powered-on at any time. For example, the signal 425-a may correspond to a sequence [x, 0, 0, x, 0, 0, x, 0, 0, 0, 0, . . . 0], the signal 425-b may correspond to a sequence [0, x, 0, 0, x, 0, 0, x, 0, 0, 0, . . . , 0], and the signal 425-c may correspond to a sequence [0, 0, x, 0, 0, x, 0, 0, x, 0, 0, . . . , 0], where the last quarter of each sequence corresponds to an OFF duration and the rest of the sequence corresponds to an ON duration.

In some examples, to generate the signals 425, the transmitter may convert each staggered modulated sample sequence (e.g., the subsequences 410) to an OFDM waveform using a respective transform 415 and a respective waveform generator 420. For example, the transmitter may convert the first staggered modulated sample sequence to a first OFDM waveform using a waveform generator 420-a, the second staggered modulated sample sequence to a second OFDM waveform using a waveform generator 420-b, and a Tth staggered modulated sample sequence to a Tth OFDM waveform using a waveform generator 420-c, where the signal 425-a is generated based on the first OFDM waveform, the signal 425-b is generated based on the second OFDM waveform, and the signal 425-c is generated based on a Tth OFDM waveform. In converting the staggered modulated sample sequences to OFDM waveforms, the transmitter may apply respective transforms 415 (e.g., a transform 415-a for the antenna 430-a, a transform 415-b for the antenna 430-b, and a transform 415-c for the antenna 430-c) to the phase-cycling modulated sample sequences. In doing so, the transmitter may convert the time-domain signal to the frequency domain such the first and second OFDM waveforms are mapped to resources corresponding to one or multiple OFDM symbols. In some cases, the transforms 415 may be M-point DFTs such that the OFDM waveforms may be DFT-S-OFDM-based modulated signals. In some examples, waveform generator 420 may perform an N point inverse fast Fourier transform (iFFT) algorithm on the output of transform 415 to generate an OFDM waveform or may be another type of OFDM waveform generator.

Additionally, the signals 425 may be low-power synchronization signals, low-power preamble signals, low-power wake-up signals, or any other low-power signal. The transmitter may transmit a low-power synchronization signal, a low-power preamble signal, a low-power wake-up signal, or any combination thereof via separate channels, or the transmitter may transmit the low-power synchronization signal and the low-power preamble signal prior to each low-power wake-up signal transmission. The receiver may use the low-power synchronization signal, the low-power preamble signal, or both to perform time or frequency synchronization with the transmitter and to train AGC of the receiver. As such, the low-power synchronization signal, the low-power preamble signal, or both may have a same dynamic range as the low-power wake-up signal, for example a same precoder cycling or a same transmission staggering pattern.

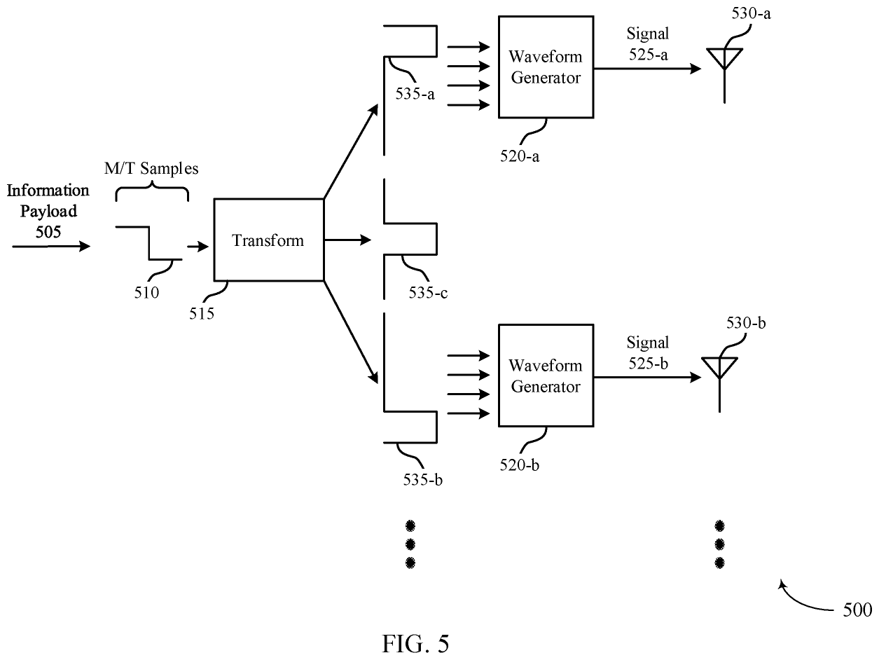

FIG. 5 illustrates an example of a transmission staggering scheme 500 that supports spatial diversity for low-power wake-up signals in accordance with one or more aspects of the present disclosure. In some examples, the transmission staggering scheme 500 may implement aspects of the wireless communications system 100 or may be implemented by aspects of the wireless communications system 100. For example, a transmitter (e.g., a wireless communication device such as a network node) may use the transmission staggering scheme 500 to generate signals 525 for transmission to a receiver (e.g., a wireless communication device such as a UE). In some examples, the transmitter may use the transmission staggering scheme 500 for cases in which the transmitter uses multiple antennas 530 to transmit low-power signals (e.g., low-power wake-up signals) to the receiver, and the receiver receives the signals using a single antenna.

A wireless communications system may support communications between the transmitter and the receiver, which may include communication of low-power wake-up signals and other low-power signals. In some examples, the transmitter may support two or more antennas, including an antenna 530-a (e.g., Tx antenna 1) and an antenna 530-b (e.g., Tx antenna T, where T may represent the total quantity of transmit antennas). As the receiver may be equipped with a single receive antenna, the transmitter may use the transmission staggering to design specific signals for transmission to the receiver such that the receiver may utilize the different channels associated with the multiple antennas 530.

In some aspects, the transmitter may receive an information payload 505 including one or more bits (e.g., 1s and 0s). The transmitter may modulate the one or more bits into a modulated sample sequence 510 for wireless transmission to the receiver via the antennas 530. The modulated sample sequence may be an OOK-modulated sample sequence, an ASK-modulated sample sequence, an FSK-modulated sample sequence, or any other low-complexity modulation-based sample sequence. In addition, the modulated sample sequence 510, which may also be referred to as a time-domain signal, may have a length of M/K samples, where M is an integer multiple of K such that each ON-OFF duration of the modulated sample sequence is a same length.

Using the transmission staggering pattern, the transmitter may stagger subsequences 535 of the modulated sample sequence 510 over frequency, for example across different subsets of resource blocks or resource elements within a frequency resource allocation), where the subsequences 535 may be portions of a low-power wake-up signal (also referred to herein as staggered modulated sample sequences). To do this, the transmitter may generate a common low-power wake-up signal (e.g., from the modulated sample sequence 510, which is then divided into the subsequences 535) with a bandwidth equal to 1/Tth of an allocated bandwidth. Then, the transmitter may place the subsequences 535 of the low-power wake-up signal on different subsets of resource blocks or resources elements of the frequency resource allocation for wake-up signal resource in the frequency domain.

In some examples, to generate the signals 525, the transmitter may convert each staggered modulated sample sequence (e.g., a subsequence 535-a, a subsequence 535-b, and a subsequence 535-c) to an OFDM waveform using a respective transform 515 and a respective waveform generator 520. For example, the transmitter may convert the first staggered modulated sample sequence to a first OFDM waveform using a waveform generator 520-a and the second staggered modulated sample sequence to a second OFDM waveform using a waveform generator 520-b, where the signal 525-a is generated based on the first OFDM waveform and the signal 525-b is generated based on the second OFDM waveform. In converting the staggered modulated sample sequences to OFDM waveforms, the transmitter may apply respective transforms 515 (e.g., a transform 515-a for the antenna 530-a and transform 515-b for the antenna 530-b) to the phase-cycling modulated sample sequences. In doing so, the transmitter may convert the time-domain signal to the frequency domain such the first and second OFDM waveforms are mapped to resources corresponding to one or multiple OFDM symbols. In some cases, the transforms 515 may be M-point DFTs such that the OFDM waveforms may be DFT-S-OFDM-based modulated signals. In an example, the waveform generator 520 may perform an N point inverse fast Fourier transform (iFFT) algorithm on the output of transform 515 to generate an OFDM waveform or may be another type of OFDM waveform generator.

Additionally, the signals 525 may be low-power synchronization signals, low-power preamble signals, low-power wake-up signals, or any other low-power signal. The transmitter may transmit a low-power synchronization signal, a low-power preamble signal, a low-power wake-up signal, or any combination thereof via separate channels, or the transmitter may transmit the low-power synchronization signal and the low-power preamble signal prior to each low-power wake-up signal transmission. The receiver may use the low-power synchronization signal, the low-power preamble signal, or both to perform time or frequency synchronization with the transmitter and to train AGC of the receiver. As such, the low-power synchronization signal, the low-power preamble signal, or both may have a same dynamic range as the low-power wake-up signal, for example a same precoder cycling or a same transmission staggering pattern.

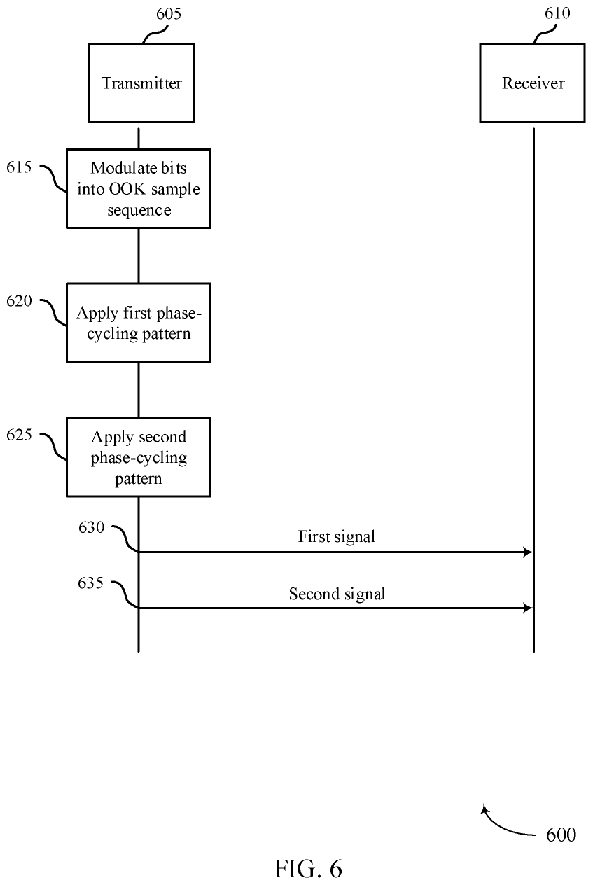

FIG. 6 illustrates an example of a process flow 600 that supports spatial diversity for low-power wake-up signals in accordance with one or more aspects of the present disclosure. The process flow 600 may implement aspects of wireless communications system 100, or may be implemented by aspects of the wireless communications system 100. For example, the process flow 600 may illustrate operations between a transmitter 605 (e.g., a network node) and a receiver 610 (e.g., a UE), which may be examples of corresponding devices described herein. In the following description of the process flow 600, the operations between the transmitter 605 and the receiver 610 may be performed in a different order than the example order shown, or the operations performed by the transmitter 605 and the receiver 610 may be performed in different orders or at different times. Some operations may also be omitted from the process flow 600, and other operations may be added to the process flow 600.

At 615, the transmitter 605 may modulate one or more bits into a modulated sample sequence for wireless transmission to the receiver 610. In some examples, the modulated sample sequence may include a time domain sample sequence of bits (e.g., 0s and 1s), where values of the bits may represent an ON duration (e.g., bits having a value of 1) or an OFF duration (e.g., bits having a value of 0). The modulated sample sequence may be an OOK-modulated sample sequence, an ASK-modulated sample sequence, or an FSK-modulated sample sequence.

At 620, the transmitter 605 may apply a first phase-cycling pattern to a set of subsequences of the modulated sample sequence to generate a first phase-cycling modulated sample sequence for transmission via a first transmit antenna. For example, the transmitter 605 may multiply a first subsequence of the set of subsequences with a first phase of the first phase-cycling pattern for the first transmit antenna.

At 625, the transmitter 605 may apply a second phase-cycling pattern to a set of subsequences of the modulated sample sequence to generate a second phase-cycling modulated sample sequence for transmission via a second transmit antenna. For example, the transmitter 605 may multiply a first subsequence of the set of subsequences with a second phase of the second phase-cycling pattern for the second transmit antenna, where the first and second phases may be different. Additionally, the transmitter may apply the first and second phase-cycling patterns to a same bit of the modulated sample sequence for each antenna.

At 630, the transmitter 605 may transmit, to the receiver 610, a first signal via the first transmit antenna based on the first phase-cycling modulated sample sequence. At 635, the transmitter 605 may transmit, to the receiver 610, a second signal via the second transmit antenna based on the second phase-cycling modulated sample sequence. The first and second signals may be low-power synchronization signals or low-power preamble signals. Additionally, based on the phase-cycling patterns, the transmissions of the first and second antennas may be non-overlapping in time. The receiver 610 may receive the first and second signals and use envelop detection to demodulate an overall signal.

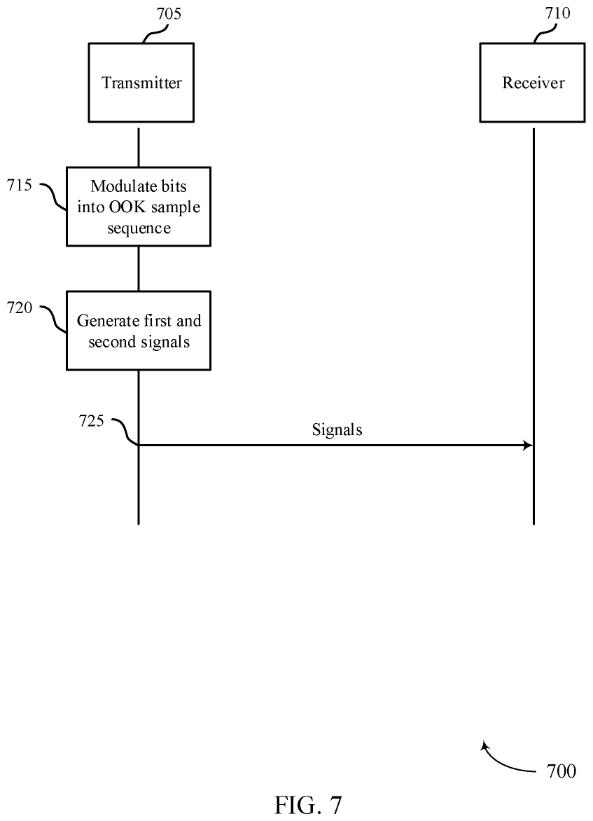

FIG. 7 illustrates an example of a process flow 700 that supports spatial diversity for low-power wake-up signals in accordance with one or more aspects of the present disclosure. The process flow 700 may implement aspects of wireless communications system 100, or may be implemented by aspects of the wireless communications system 100. For example, the process flow 700 may illustrate operations between a transmitter 705 (e.g., a network node) and a receiver 710 (e.g., a UE), which may be examples of corresponding devices described herein. In the following description of the process flow 700, the operations between the transmitter 705 and the receiver 710 may be performed in a different order than the example order shown, or the operations performed by the transmitter 705 and the receiver 710 may be performed in different orders or at different times. Some operations may also be omitted from the process flow 700, and other operations may be added to the process flow 700.

At 715, the transmitter 705 may modulate one or more bits into a modulated sample sequence for wireless transmission to a receiver. In some examples, the modulated sample sequence may include a time domain sample sequence of bits (e.g., 0s and 1s), where values of the bits may represent an ON duration (e.g., bits having a value of 1) or an OFF duration (e.g., bits having a value of 0). The modulated sample sequence may be an OOK-modulated sample sequence, an ASK-modulated sample sequence, or an FSK-modulated sample sequence.

At 720, the transmitter 705 may generate, in accordance with a transmission staggering pattern, a first signal from the modulated sample sequence for transmission via a first transmit antenna and a second signal from the modulated sample sequence for transmission via a second transmit antenna. In some examples, the transmission staggering pattern may indicate to stagger the transmission of the first and second signals across different frequency subbands of a resource allocation. Additionally, or alternatively, the transmission staggering pattern may indicate to apply a phase ramp in the frequency domain to generate the first and second signals.

At 725, the transmitter 705 may transmit, to the receiver 710, the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern. The receiver 710 may receive the first and second signals and use envelop detection to demodulate an overall signal.

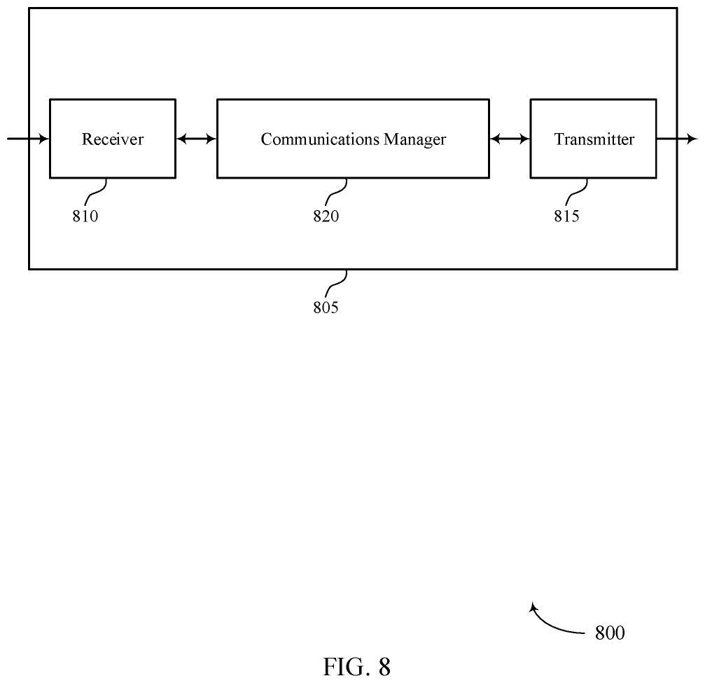

FIG. 8 illustrates a block diagram 800 of a device 805 that supports spatial diversity for low-power wake-up signals in accordance with one or more aspects of the present disclosure. The device 805 may be an example of aspects of a transmitter as described herein. The device 805 may include a receiver 810, a transmitter 815, and a communications manager 820. The device 805 may also include one or more processors, memory coupled with the one or more processors, and instructions stored in the memory that are executable by the one or more processors to enable the one or more processors to perform the signal modulation features discussed herein. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of spatial diversity for low-power wake-up signals as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a transmitter in accordance with examples as disclosed herein. For example, the communications manager 820 may be configured as or otherwise support a means for modulating one or more bits into a modulated sample sequence for wireless transmission to a receiver. The communications manager 820 may be configured as or otherwise support a means for applying a first phase-cycling pattern to a set of multiple subsequences of the modulated sample sequence to generate a first phase-cycling modulated sample sequence for transmission via a first transmit antenna. The communications manager 820 may be configured as or otherwise support a means for applying a second phase-cycling pattern to the set of multiple subsequences of the modulated sample sequence to generate a second phase-cycling modulated sample sequence for transmission via a second transmit antenna. The communications manager 820 may be configured as or otherwise support a means for transmitting a first signal via the first transmit antenna based on the first phase-cycling modulated sample sequence. The communications manager 820 may be configured as or otherwise support a means for transmitting a second signal via the second transmit antenna based on the second phase-cycling modulated sample sequence.

Additionally, or alternatively, the communications manager 820 may support wireless communication at a transmitter in accordance with examples as disclosed herein. For example, the communications manager 820 may be configured as or otherwise support a means for modulating one or more bits into a modulated sample sequence for wireless transmission to a receiver. The communications manager 820 may be configured as or otherwise support a means for generating, in accordance with a transmission staggering pattern, a first signal from the modulating sample sequence for transmission via a first transmit antenna and a second signal from the modulated sample sequence for transmission via a second transmit antenna. The communications manager 820 may be configured as or otherwise support a means for transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for transmitting low-power signals in accordance with a phase-cycling pattern or a transmission staggering pattern, which may increase spatial diversity and decrease power consumption at a receiver.

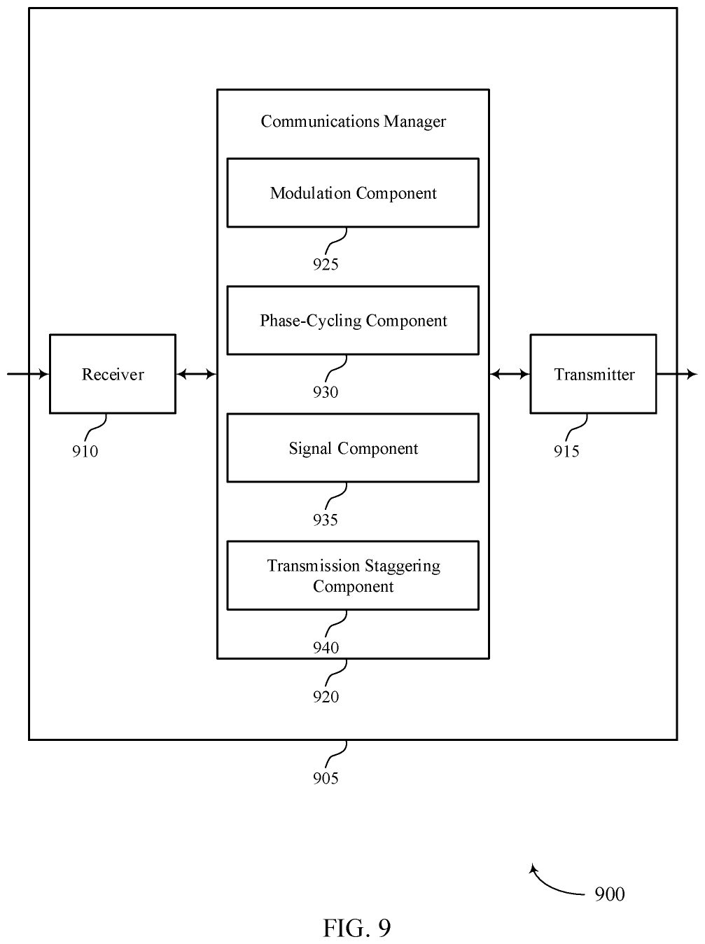

FIG. 9 illustrates a block diagram 900 of a device 905 that supports spatial diversity for low-power wake-up signals in accordance with one or more aspects of the present disclosure. The device 905 may be an example of aspects of a device 805 or a transmitter 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of spatial diversity for low-power wake-up signals as described herein. For example, the communications manager 920 may include a modulation component 925, a phase-cycling component 930, a signal component 935, a transmission staggering component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a transmitter in accordance with examples as disclosed herein. The modulation component 925 may be configured as or otherwise support a means for modulating one or more bits into a modulated sample sequence for wireless transmission to a receiver. The phase-cycling component 930 may be configured as or otherwise support a means for applying a first phase-cycling pattern to a set of multiple subsequences of the modulated sample sequence to generate a first phase-cycling modulated sample sequence for transmission via a first transmit antenna. The phase-cycling component 930 may be configured as or otherwise support a means for applying a second phase-cycling pattern to the set of multiple subsequences of the modulated sample sequence to generate a second phase-cycling modulated sample sequence for transmission via a second transmit antenna. The signal component 935 may be configured as or otherwise support a means for transmitting a first signal via the first transmit antenna based on the first phase-cycling modulated sample sequence. The signal component 935 may be configured as or otherwise support a means for transmitting a second signal via the second transmit antenna based on the second phase-cycling modulated sample sequence.

Additionally, or alternatively, the communications manager 920 may support wireless communication at a transmitter in accordance with examples as disclosed herein. The modulation component 925 may be configured as or otherwise support a means for modulating one or more bits into a modulated sample sequence for wireless transmission to a receiver. The transmission staggering component 940 may be configured as or otherwise support a means for generating, in accordance with a transmission staggering pattern, a first signal from the modulated sample sequence for transmission via a first transmit antenna and a second signal from the modulated sample sequence for transmission via a second transmit antenna. The signal component 935 may be configured as or otherwise support a means for transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern.

In some cases, the modulation component 925, the phase-cycling component 930, the signal component 935, and the transmission staggering component 940 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the modulation component 925, the phase-cycling component 930, the signal component 935, and the transmission staggering component 940 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

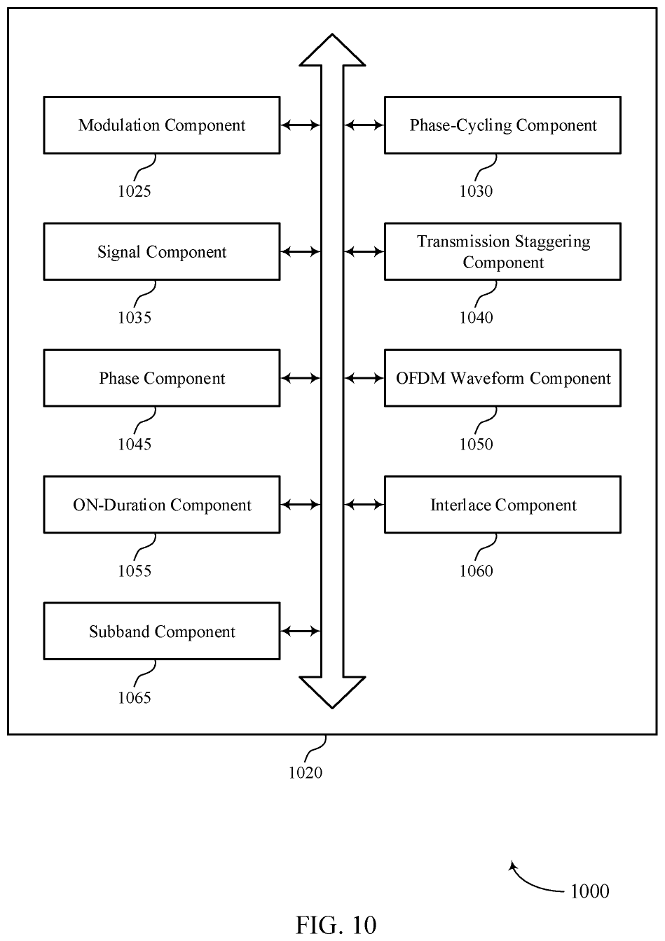

FIG. 10 illustrates a block diagram 1000 of a communications manager 1020 that supports spatial diversity for low-power wake-up signals in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of spatial diversity for low-power wake-up signals as described herein. For example, the communications manager 1020 may include a modulation component 1025, a phase-cycling component 1030, a signal component 1035, a transmission staggering component 1040, a phase component 1045, an OFDM waveform component 1050, a ON-duration component 1055, an interlace component 1060, a subband component 1065, or any combination thereof. Each of these components may communicate, directly or indirectly, with one another (e.g., via one or more buses).

The communications manager 1020 may support wireless communication at a transmitter in accordance with examples as disclosed herein. The modulation component 1025 may be configured as or otherwise support a means for modulating one or more bits into a modulated sample sequence for wireless transmission to a receiver. The phase-cycling component 1030 may be configured as or otherwise support a means for applying a first phase-cycling pattern to a set of multiple subsequences of the modulated sample sequence to generate a first phase-cycling modulated sample sequence for transmission via a first transmit antenna. In some examples, the phase-cycling component 1030 may be configured as or otherwise support a means for applying a second phase-cycling pattern to the set of multiple subsequences of the modulated sample sequence to generate a second phase-cycling modulated sample sequence for transmission via a second transmit antenna. The signal component 1035 may be configured as or otherwise support a means for transmitting a first signal via the first transmit antenna based on the first phase-cycling modulated sample sequence. In some examples, the signal component 1035 may be configured as or otherwise support a means for transmitting a second signal via the second transmit antenna based on the second phase-cycling modulated sample sequence.

In some examples, the phase component 1045 may be configured as or otherwise support a means for multiplying a first subsequence of the set of multiple subsequences with a first phase of the first phase-cycling pattern for the first transmit antenna and the first subsequence of the set of multiple subsequences with a second phase of the second phase-cycling pattern for the second transmit antenna, where the first phase is different from the second phase.

In some examples, the phase-cycling component 1030 may be configured as or otherwise support a means for applying the first phase-cycling pattern to a first bit of the modulated sample sequence and the second phase-cycling pattern to the first bit of the modulated sample sequence.

In some examples, the OFDM waveform component 1050 may be configured as or otherwise support a means for converting the first phase-cycling modulated sample sequence to a first OFDM waveform and the second phase-cycling modulated sample sequence to a second OFDM waveform, where the first signal is generated based on the first OFDM waveform and the second signal is generated based on the second OFDM waveform.

In some examples, the first OFDM waveform and the second OFDM waveform are mapped to resources corresponding to a single OFDM symbol.

In some examples, the first OFDM waveform and the second OFDM waveform are mapped to resources corresponding to a set of multiple OFDM symbols.

In some examples, the first signal and the second signal are associated with a zero mean. In some examples, the first phase-cycling modulated sample sequence and the second phase-cycling modulated sample sequence are each associated with a zero mean.

In some examples, the first signal and the second signal include low-power synchronization signals, low-power preamble signals, low-power wake-up signals, or any combination thereof. In some examples, the modulated sample sequence includes an OOK sample sequence, an ASK sample sequence, or a FSK sample sequence.

Additionally, or alternatively, the communications manager 1020 may support wireless communication at a transmitter in accordance with examples as disclosed herein. In some examples, the modulation component 1025 may be configured as or otherwise support a means for modulating one or more bits into a modulated sample sequence for wireless transmission to a receiver. The transmission staggering component 1040 may be configured as or otherwise support a means for generating, in accordance with a transmission staggering pattern, a first signal from the modulated sample sequence for transmission via a first transmit antenna and a second signal from the modulated sample sequence for transmission via a second transmit antenna. In some examples, the signal component 1035 may be configured as or otherwise support a means for transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern. In some examples, the transmission staggering pattern indicates to stagger the transmission of the first signal and the second signal across different frequency subbands of a resource allocation.

In some examples, to support transmitting the first signal and the second signal, the ON-duration component 1055 may be configured as or otherwise support a means for transmitting the first signal during a first portion of an on-duration of the modulated sample sequence and the second signal during a second portion of the on-duration of the modulated sample sequence, where the first portion and the second portion of the on-duration occur at the non-overlapping times in accordance with the transmission staggering pattern.

In some examples, a first transmission power level associated with the first signal during the first portion of the on-duration is equal to a second transmission power level associated with the second signal during the second portion of the on-duration.

In some examples, to support transmitting the first signal and the second signal, the interlace component 1060 may be configured as or otherwise support a means for transmitting the first signal that is a first interlace during a first portion of an on-duration of the modulated sample sequence and the second signal that is a second interlace during a second portion of the on-duration of the modulated sample sequence, where the first interlace and the second interlace are non-overlapping in time in accordance with the transmission staggering pattern.

In some examples, the subband component 1065 may be configured as or otherwise support a means for transmitting the first signal via the first transmit antenna in a first subband of an allocated bandwidth and the second signal via the second transmit antenna using a second subband of the allocated bandwidth, where the first subband is different from the second subband.

In some examples, to support generating the first signal and the second signal, the transmission staggering component 1040 may be configured as or otherwise support a means for generating, in accordance with the transmission staggering pattern that indicates to apply a phase ramp in a frequency domain, the first signal and the second signal.

In some examples, the OFDM waveform component 1050 may be configured as or otherwise support a means for converting a first staggered modulated sample sequence to a first OFDM waveform and a second staggered modulated sample sequence to a second OFDM waveform, where the first signal is generated based on the first OFDM waveform and the second signal is generated based on the second OFDM waveform.

In some examples, the first OFDM waveform and the second OFDM waveform are mapped to resources corresponding to a single OFDM symbol.

In some examples, the first OFDM waveform and the second OFDM waveform are mapped to resources corresponding to a set of multiple OFDM symbols.

In some examples, the first signal and the second signal include low-power synchronization signals, low-power preamble signals, low-power wake-up signals, or any combination thereof. In some examples, the modulated sample sequence includes an OOK sample sequence, an ASK sample sequence, or a FSK sample sequence.

In some cases, the modulation component 1025, the phase-cycling component 1030, the signal component 1035, the transmission staggering component 1040, the phase component 1045, the OFDM waveform component 1050, the ON-duration component 1055, the interlace component 1060, and the subband component 1065 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the modulation component 1025, the phase-cycling component 1030, the signal component 1035, the transmission staggering component 1040, the phase component 1045, the OFDM waveform component 1050, the ON-duration component 1055, the interlace component 1060, and the subband component 1065 discussed herein.

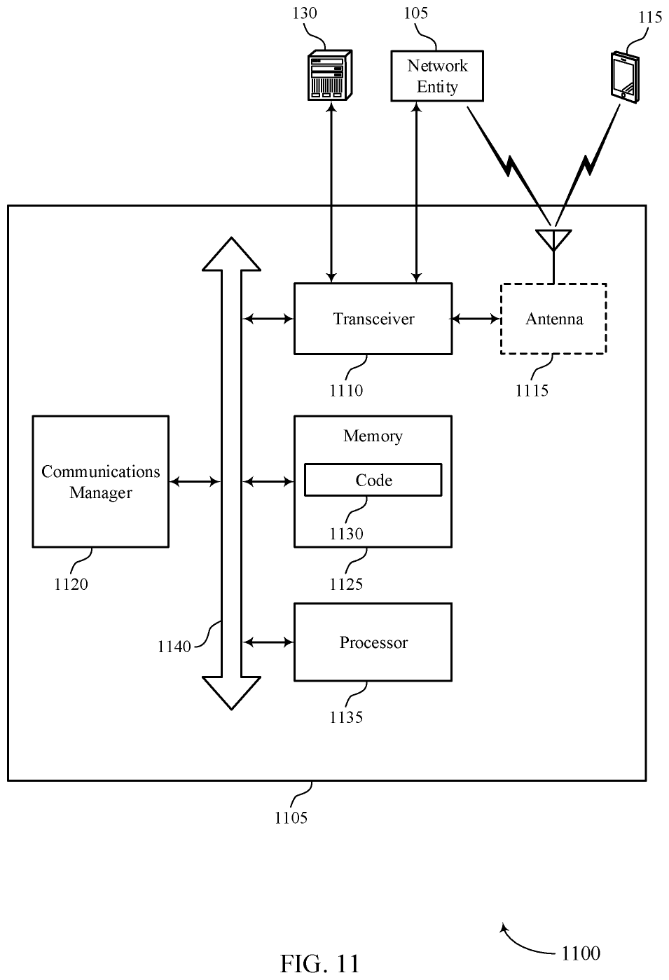

FIG. 11 illustrates a diagram of a system 1100 including a device 1105 that supports spatial diversity for low-power wake-up signals in accordance with one or more aspects of the present disclosure. The device 1105 may be an example of or include the components of a device 805, a device 905, or a transmitter as described herein. The device 1105 may include components for bi-directional voice and data communications including components for transmitting and receiving communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting spatial diversity for low-power wake-up signals). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a transmitter in accordance with examples as disclosed herein. For example, the communications manager 1120 may be configured as or otherwise support a means for modulating one or more bits into a modulated sample sequence for wireless transmission to a receiver. The communications manager 1120 may be configured as or otherwise support a means for applying a first phase-cycling pattern to a set of multiple subsequences of the modulated sample sequence to generate a first phase-cycling modulated sample sequence for transmission via a first transmit antenna. The communications manager 1120 may be configured as or otherwise support a means for applying a second phase-cycling pattern to the set of multiple subsequences of the modulated sample sequence to generate a second phase-cycling modulated sample sequence for transmission via a second transmit antenna. The communications manager 1120 may be configured as or otherwise support a means for transmitting a first signal via the first transmit antenna based on the first phase-cycling modulated sample sequence. The communications manager 1120 may be configured as or otherwise support a means for transmitting a second signal via the second transmit antenna based on the second phase-cycling modulated sample sequence.

Additionally, or alternatively, the communications manager 1120 may support wireless communication at a transmitter in accordance with examples as disclosed herein. For example, the communications manager 1120 may be configured as or otherwise support a means for modulating one or more bits into a modulated sample sequence for wireless transmission to a receiver. The communications manager 1120 may be configured as or otherwise support a means for generating, in accordance with a transmission staggering pattern, a first signal from the modulating sample sequence for transmission via a first transmit antenna and a second signal from the modulated sample sequence for transmission via a second transmit antenna. The communications manager 1120 may be configured as or otherwise support a means for transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern.

By including or configuring the communications manager 1120 in accordance with examples as described herein, the device 1105 may support techniques for transmission staggering pattern, which may increase spatial diversity and decrease power consumption at a receiver.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of spatial diversity for low-power wake-up signals as described herein, or the processor 1135 and the memory 1125 may be otherwise configured to perform or support such operations.

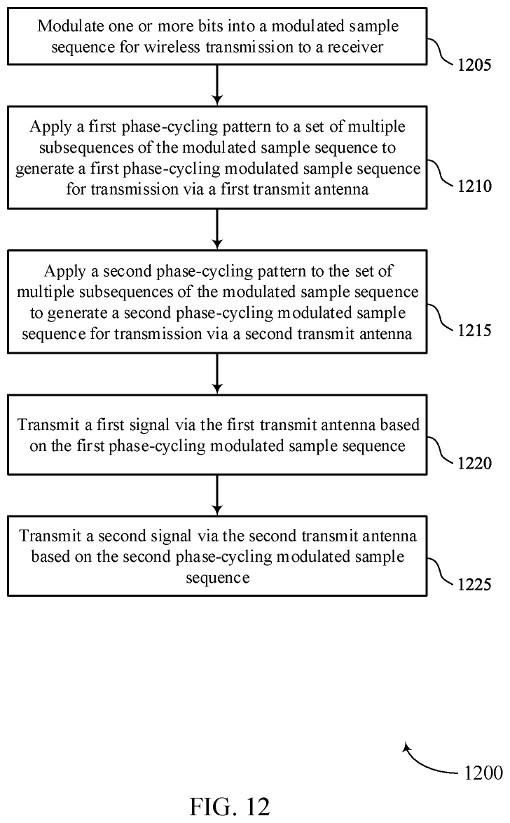

FIG. 12 illustrates a flowchart illustrating a method 1200 that supports spatial diversity for low-power wake-up signals in accordance with one or more aspects of the present disclosure. The operations of the method 1200 may be implemented by a transmitter or its components as described herein. For example, the operations of the method 1200 may be performed by a transmitter as described with reference to FIGS. 1 through 11. In some examples, a transmitter may execute a set of instructions to control the functional elements of the transmitter to perform the described functions. Additionally, or alternatively, the transmitter may perform aspects of the described functions using special-purpose hardware.

At 1205, the method may include modulating one or more bits into a modulated sample sequence for wireless transmission to a receiver. The operations of 1205 may be performed in accordance with examples as disclosed herein. In some examples, aspects of the operations of 1205 may be performed by a modulation component 1025 as described with reference to FIG. 10.

At 1210, the method may include applying a first phase-cycling pattern to a set of multiple subsequences of the modulated sample sequence to generate a first phase-cycling modulated sample sequence for transmission via a first transmit antenna. The operations of 1210 may be performed in accordance with examples as disclosed herein. In some examples, aspects of the operations of 1210 may be performed by a phase-cycling component 1030 as described with reference to FIG. 10.

At 1215, the method may include applying a second phase-cycling pattern to the set of multiple subsequences of the modulated sample sequence to generate a second phase-cycling modulated sample sequence for transmission via a second transmit antenna. The operations of 1215 may be performed in accordance with examples as disclosed herein. In some examples, aspects of the operations of 1215 may be performed by a phase-cycling component 1030 as described with reference to FIG. 10.

At 1220, the method may include transmitting a first signal via the first transmit antenna based on the first phase-cycling modulated sample sequence. The operations of 1220 may be performed in accordance with examples as disclosed herein. In some examples, aspects of the operations of 1220 may be performed by a signal component 1035 as described with reference to FIG. 10.

At 1225, the method may include transmitting a second signal via the second transmit antenna based on the second phase-cycling modulated sample sequence. The operations of 1225 may be performed in accordance with examples as disclosed herein. In some examples, aspects of the operations of 1225 may be performed by a signal component 1035 as described with reference to FIG. 10.

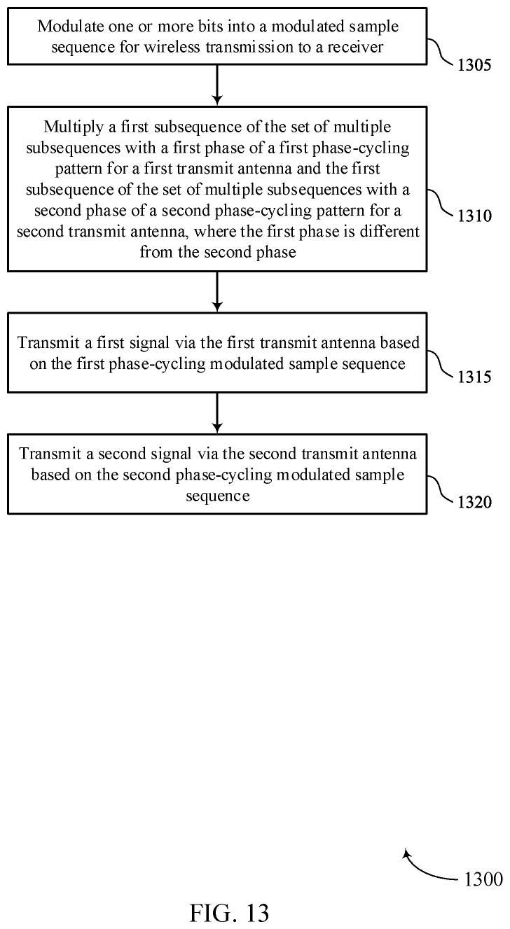

FIG. 13 illustrates a flowchart illustrating a method 1300 that supports spatial diversity for low-power wake-up signals in accordance with one or more aspects of the present disclosure. The operations of the method 1300 may be implemented by a transmitter or its components as described herein. For example, the operations of the method 1300 may be performed by a transmitter as described with reference to FIGS. 1 through 11. In some examples, a transmitter may execute a set of instructions to control the functional elements of the transmitter to perform the described functions. Additionally, or alternatively, the transmitter may perform aspects of the described functions using special-purpose hardware.

At 1305, the method may include modulating one or more bits into a modulated sample sequence for wireless transmission to a receiver. The operations of 1305 may be performed in accordance with examples as disclosed herein. In some examples, aspects of the operations of 1305 may be performed by a modulation component 1025 as described with reference to FIG. 10.

At 1310, the method may include multiplying a first subsequence of the set of multiple subsequences with a first phase of a first phase-cycling pattern for a first transmit antenna and the first subsequence of the set of multiple subsequences with a second phase of a second phase-cycling pattern for a second transmit antenna, where the first phase is different from the second phase. The operations of 1310 may be performed in accordance with examples as disclosed herein. In some examples, aspects of the operations of 1310 may be performed by a phase component 1045 as described with reference to FIG. 10.

At 1315, the method may include transmitting a first signal via the first transmit antenna based on the first phase-cycling modulated sample sequence. The operations of 1315 may be performed in accordance with examples as disclosed herein. In some examples, aspects of the operations of 1315 may be performed by a signal component 1035 as described with reference to FIG. 10.

At 1320, the method may include transmitting a second signal via the second transmit antenna based on the second phase-cycling modulated sample sequence. The operations of 1320 may be performed in accordance with examples as disclosed herein. In some examples, aspects of the operations of 1320 may be performed by a signal component 1035 as described with reference to FIG. 10.

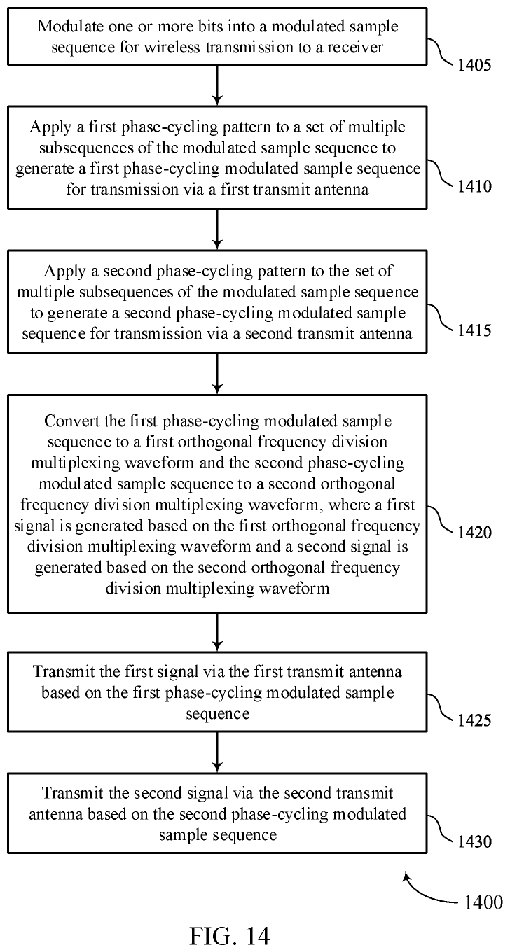

FIG. 14 illustrates a flowchart illustrating a method 1400 that supports spatial diversity for low-power wake-up signals in accordance with one or more aspects of the present disclosure. The operations of the method 1400 may be implemented by a transmitter or its components as described herein. For example, the operations of the method 1400 may be performed by a transmitter as described with reference to FIGS. 1 through 11. In some examples, a transmitter may execute a set of instructions to control the functional elements of the transmitter to perform the described functions. Additionally, or alternatively, the transmitter may perform aspects of the described functions using special-purpose hardware.

At 1405, the method may include modulating one or more bits into a modulated sample sequence for wireless transmission to a receiver. The operations of 1405 may be performed in accordance with examples as disclosed herein. In some examples, aspects of the operations of 1405 may be performed by a modulation component 1025 as described with reference to FIG. 10.

At 1410, the method may include applying a first phase-cycling pattern to a set of multiple subsequences of the modulated sample sequence to generate a first phase-cycling modulated sample sequence for transmission via a first transmit antenna. The operations of 1410 may be performed in accordance with examples as disclosed herein. In some examples, aspects of the operations of 1410 may be performed by a phase-cycling component 1030 as described with reference to FIG. 10.

At 1415, the method may include applying a second phase-cycling pattern to the set of multiple subsequences of the modulated sample sequence to generate a second phase-cycling modulated sample sequence for transmission via a second transmit antenna. The operations of 1415 may be performed in accordance with examples as disclosed herein. In some examples, aspects of the operations of 1415 may be performed by a phase-cycling component 1030 as described with reference to FIG. 10.

At 1420, the method may include converting the first phase-cycling modulated sample sequence to a first OFDM waveform and the second phase-cycling modulated sample sequence to a second OFDM waveform, where a first signal is generated based on the first OFDM waveform and a second signal is generated based on the second OFDM waveform. The operations of 1420 may be performed in accordance with examples as disclosed herein. In some examples, aspects of the operations of 1420 may be performed by an OFDM waveform component 1050 as described with reference to FIG. 10.

At 1425, the method may include transmitting the first signal via the first transmit antenna based on the first phase-cycling modulated sample sequence. The operations of 1425 may be performed in accordance with examples as disclosed herein. In some examples, aspects of the operations of 1425 may be performed by a signal component 1035 as described with reference to FIG. 10.

At 1430, the method may include transmitting the second signal via the second transmit antenna based on the second phase-cycling modulated sample sequence. The operations of 1430 may be performed in accordance with examples as disclosed herein. In some examples, aspects of the operations of 1430 may be performed by a signal component 1035 as described with reference to FIG. 10.

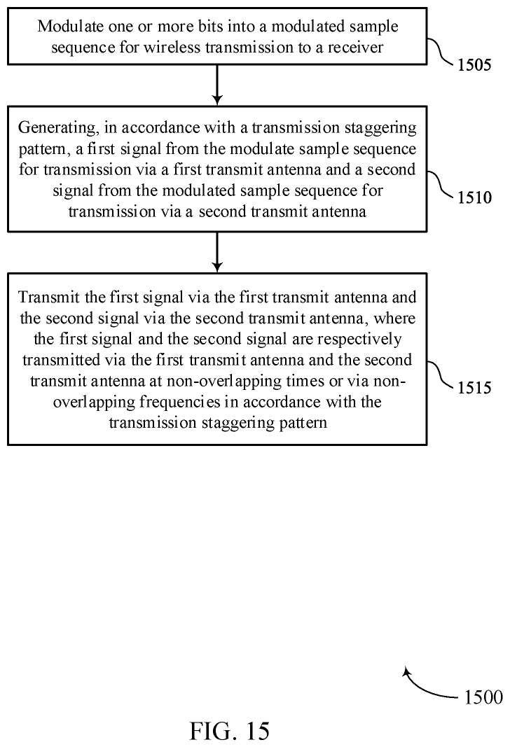

FIG. 15 illustrates a flowchart illustrating a method 1500 that supports spatial diversity for low-power wake-up signals in accordance with one or more aspects of the present disclosure. The operations of the method 1500 may be implemented by a transmitter or its components as described herein. For example, the operations of the method 1500 may be performed by a transmitter as described with reference to FIGS. 1 through 11. In some examples, a transmitter may execute a set of instructions to control the functional elements of the transmitter to perform the described functions. Additionally, or alternatively, the transmitter may perform aspects of the described functions using special-purpose hardware.

At 1505, the method may include modulating one or more bits into a modulated sample sequence for wireless transmission to a receiver. The operations of 1505 may be performed in accordance with examples as disclosed herein. In some examples, aspects of the operations of 1505 may be performed by a modulation component 1025 as described with reference to FIG. 10.

At 1510, the method may include generating, in accordance with a transmission staggering pattern, a first signal from the modulated sample sequence for transmission via a first transmit antenna and a second signal from the modulated sample sequence for transmission via a second transmit antenna. The operations of 1510 may be performed in accordance with examples as disclosed herein. In some examples, aspects of the operations of 1510 may be performed by a transmission staggering component 1040 as described with reference to FIG. 10.

At 1515, the method may include transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern. The operations of 1515 may be performed in accordance with examples as disclosed herein. In some examples, aspects of the operations of 1515 may be performed by a signal component 1035 as described with reference to FIG. 10.

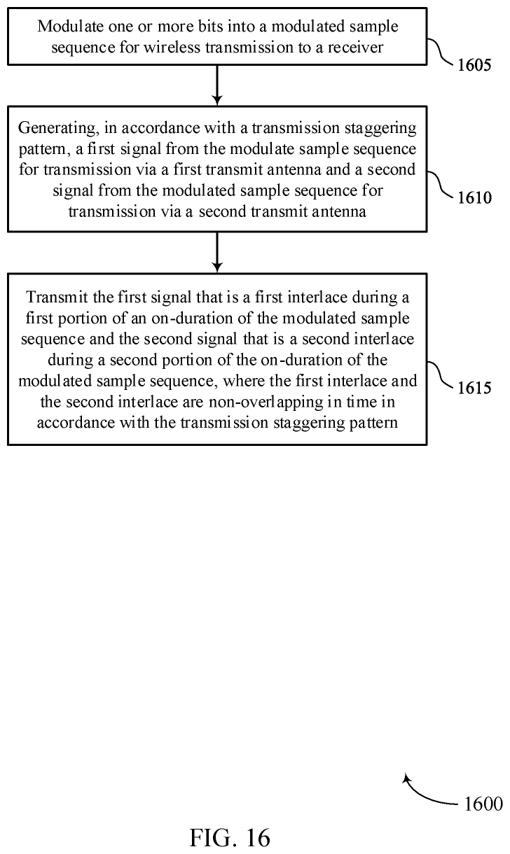

FIG. 16 illustrates a flowchart illustrating a method 1600 that supports spatial diversity for low-power wake-up signals in accordance with one or more aspects of the present disclosure. The operations of the method 1600 may be implemented by a transmitter or its components as described herein. For example, the operations of the method 1600 may be performed by a transmitter as described with reference to FIGS. 1 through 11. In some examples, a transmitter may execute a set of instructions to control the functional elements of the transmitter to perform the described functions. Additionally, or alternatively, the transmitter may perform aspects of the described functions using special-purpose hardware.

At 1605, the method may include modulating one or more bits into a modulated sample sequence for wireless transmission to a receiver. The operations of 1605 may be performed in accordance with examples as disclosed herein. In some examples, aspects of the operations of 1605 may be performed by a modulation component 1025 as described with reference to FIG. 10.

At 1610, the method may include generating, in accordance with a transmission staggering pattern, a first signal from the modulated sample sequence for transmission via a first transmit antenna and a second signal from the modulated sample sequence for transmission via a second transmit antenna. The operations of 1610 may be performed in accordance with examples as disclosed herein. In some examples, aspects of the operations of 1610 may be performed by a transmission staggering component 1040 as described with reference to FIG. 10.

At 1615, the method may include transmitting the first signal that is a first interlace during a first portion of an on-duration of the modulated sample sequence and the second signal that is a second interlace during a second portion of the on-duration of the modulated sample sequence, where the first interlace and the second interlace are non-overlapping in time in accordance with the transmission staggering pattern. The operations of 1615 may be performed in accordance with examples as disclosed herein. In some examples, aspects of the operations of 1615 may be performed by an interlace component 1060 as described with reference to FIG. 10.

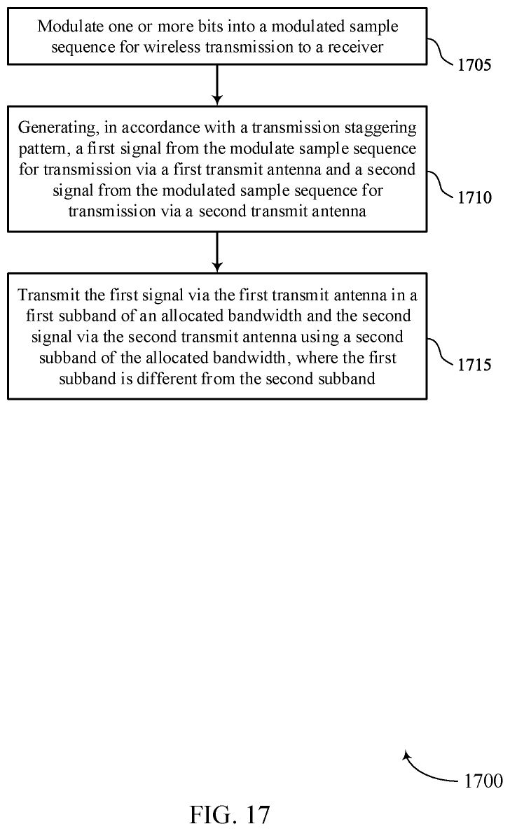

FIG. 17 illustrates a flowchart illustrating a method 1700 that supports spatial diversity for low-power wake-up signals in accordance with one or more aspects of the present disclosure. The operations of the method 1700 may be implemented by a transmitter or its components as described herein. For example, the operations of the method 1700 may be performed by a transmitter as described with reference to FIGS. 1 through 11. In some examples, a transmitter may execute a set of instructions to control the functional elements of the transmitter to perform the described functions. Additionally, or alternatively, the transmitter may perform aspects of the described functions using special-purpose hardware.

At 1705, the method may include modulating one or more bits into a modulated sample sequence for wireless transmission to a receiver. The operations of 1705 may be performed in accordance with examples as disclosed herein. In some examples, aspects of the operations of 1705 may be performed by a modulation component 1025 as described with reference to FIG. 10.

At 1710, the method may include generating, in accordance with a transmission staggering pattern, a first signal from the modulated sample sequence for transmission via a first transmit antenna and a second signal from the modulated sample sequence for transmission via a second transmit antenna. The operations of 1710 may be performed in accordance with examples as disclosed herein. In some examples, aspects of the operations of 1710 may be performed by a transmission staggering component 1040 as described with reference to FIG. 10.

At 1720, the method may include transmitting the first signal via the first transmit antenna and the second signal via the second transmit antenna, where the first signal and the second signal are respectively transmitted via the first transmit antenna and the second transmit antenna at non-overlapping times or via non-overlapping frequencies in accordance with the transmission staggering pattern. The operations of 1720 may be performed in accordance with examples as disclosed herein. In some examples, aspects of the operations of 1720 may be performed by a signal component 1035 as described with reference to FIG. 10.

The following provides an overview of aspects of the present disclosure:

Aspect 1: A method for wireless communication at a transmitter, comprising: modulating one or more bits into a modulated sample sequence for wireless transmission to a receiver; applying a first phase-cycling pattern to a plurality of subsequences of the modulated sample sequence to generate a first phase-cycling modulated sample sequence for transmission via a first transmit antenna; applying a second phase-cycling pattern to the plurality of subsequences of the modulated sample sequence to generate a second phase-cycling modulated sample sequence for transmission via a second transmit antenna; transmitting a first signal via the first transmit antenna based at least in part on the first phase-cycling modulated sample sequence; and transmitting a second signal via the second transmit antenna based at least in part on the second phase-cycling modulated sample sequence.

Aspect 2: The method of aspect 1, further comprising: multiplying a first subsequence of the plurality of subsequences with a first phase of the first phase-cycling pattern for the first transmit antenna and the first subsequence of the plurality of subsequences with a second phase of the second phase-cycling pattern for the second transmit antenna, wherein the first phase is different from the second phase.

Aspect 3: The method of any of aspects 1 through 2, further comprising: applying the first phase-cycling pattern to a first bit of the modulated sample sequence and the second phase-cycling pattern to the first bit of the modulated sample sequence.

Aspect 4: The method of any of aspects 1 through 3, further comprising: converting the first phase-cycling modulated sample sequence to a first OFDM waveform and the second phase-cycling modulated sample sequence to a second OFDM waveform, wherein the first signal is generated based at least in part on the first OFDM waveform and the second signal is generated based at least in part on the second OFDM waveform.

Aspect 5: The method of aspect 4, wherein the first OFDM waveform and the second OFDM waveform are mapped to resources corresponding to a single OFDM symbol.

Aspect 6: The method of any of aspects 4 through 5, wherein the first OFDM waveform and the second OFDM waveform are mapped to resources corresponding to a plurality of OFDM symbols.

Aspect 7: The method of any of aspects 1 through 6, wherein the first signal and the second signal are associated with a zero mean.

Aspect 8: The method of any of aspects 1 through 7, wherein the first phase-cycling modulated sample sequence and the second phase-cycling modulated sample sequence are each associated with a zero mean.

Aspect 9: The method of any of aspects 1 through 8, wherein the first signal and the second signal comprise low-power synchronization signals, low-power preamble signals, low-power wake-up signals, or any combination thereof.

Aspect 10: The method of any of aspects 1 through 9, wherein the modulated sample sequence comprises an OOK sample sequence, an ASK sample sequence, or a FSK sample sequence.

Aspect 11: A method for wireless communication at a transmitter, comprising: modulating one or more bits into a modulated sample sequence for wireless transmission to a receiver; generating, in accordance with a transmission staggering pattern, a first signal from the modulated sample sequence for transmission via a first transmit antenna and a second signal from the modulated sample sequence for transmission via a second transmit antenna; and transmitting the first signal via the first transmit antenna and the second signal via the second transmit antenna, wherein the first signal and the second signal are respectively transmitted via the first transmit antenna and the second transmit antenna at non-overlapping times or via non-overlapping frequencies in accordance with the transmission staggering pattern.

Aspect 12: The method of aspect 11, wherein the transmission staggering pattern indicates to stagger the transmission of the first signal and the second signal across different frequency subbands of a resource allocation.

Aspect 13: The method of any of aspects 11 through 12, wherein transmitting the first signal and the second signal comprises: transmitting the first signal during a first portion of an on-duration of the modulated sample sequence and the second signal during a second portion of the on-duration of the modulated sample sequence, wherein the first portion and the second portion of the on-duration occur at the non-overlapping times in accordance with the transmission staggering pattern.

Aspect 14: The method of aspect 13, further comprising: a first transmission power level associated with the first signal during the first portion of the on-duration is equal to a second transmission power level associated with the second signal during the second portion of the on-duration.

Aspect 15: The method of any of aspects 11 through 14, wherein transmitting the first signal and the second signal comprises: transmitting the first signal that is a first interlace during a first portion of an on-duration of the modulated sample sequence and the second signal that is a second interlace during a second portion of the on-duration of the modulated sample sequence, wherein the first interlace and the second interlace are non-overlapping in time in accordance with the transmission staggering pattern.

Aspect 16: The method of any of aspects 11 through 15, further comprising: transmitting the first signal via the first transmit antenna in a first subband of an allocated bandwidth and the second signal via the second transmit antenna using a second subband of the allocated bandwidth, wherein the first subband is different from the second subband.

Aspect 17: The method of any of aspects 11 through 16, wherein generating the first signal and the second signal comprises: generating, in accordance with the transmission staggering pattern that indicates to apply a phase ramp in a frequency domain, the first signal and the second signal.

Aspect 18: The method of any of aspects 11 through 17, further comprising: converting a first staggered modulated sample sequence to a first OFDM waveform and a second staggered modulated sample sequence to a second OFDM waveform, wherein the first signal is generated based at least in part on the first OFDM waveform and the second signal is generated based at least in part on the second OFDM waveform.

Aspect 19: The method of aspect 18, wherein the first OFDM waveform and the second OFDM waveform are mapped to resources corresponding to a single OFDM symbol.

Aspect 20: The method of any of aspects 18 through 19, wherein the first OFDM waveform and the second OFDM waveform are mapped to resources corresponding to a plurality of OFDM symbols.

Aspect 21: The method of any of aspects 11 through 20, wherein the first signal and the second signal comprise low-power synchronization signals, low-power preamble signals, low-power wake-up signals, or any combination thereof.

Aspect 22: The method of any of aspects 11 through 21, wherein the modulated sample sequence comprises an OOK sample sequence, an ASK sample sequence, or a FSK sample sequence.

Aspect 23: An apparatus for wireless communication at a transmitter, comprising a processor; memory coupled with the processor; and instructions stored in the memory and executable by the processor to cause the apparatus to perform a method of any of aspects 1 through 10.

Aspect 24: An apparatus for wireless communication at a transmitter, comprising at least one means for performing a method of any of aspects 1 through 10.

Aspect 25: A non-transitory computer-readable medium storing code for wireless communication at a transmitter, the code comprising instructions executable by a processor to perform a method of any of aspects 1 through 10.

Aspect 26: An apparatus for wireless communication at a transmitter, comprising a processor; memory coupled with the processor; and instructions stored in the memory and executable by the processor to cause the apparatus to perform a method of any of aspects 11 through 22.

Aspect 27: An apparatus for wireless communication at a transmitter, comprising at least one means for performing a method of any of aspects 11 through 22.

Aspect 28: A non-transitory computer-readable medium storing code for wireless communication at a transmitter, the code comprising instructions executable by a processor to perform a method of any of aspects 11 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a transmitter, comprising:
a processor;
memory coupled with the processor; and
instructions stored in the memory and executable by the processor to cause the apparatus to:
modulate one or more bits into a modulated sample sequence for wireless transmission to a receiver;
apply a first phase-cycling pattern to a plurality of subsequences of the modulated sample sequence to generate a first phase-cycling modulated sample sequence for transmission via a first transmit antenna;
apply a second phase-cycling pattern to the plurality of subsequences of the modulated sample sequence to generate a second phase-cycling modulated sample sequence for transmission via a second transmit antenna;
transmit a first signal via the first transmit antenna based at least in part on the first phase-cycling modulated sample sequence; and
transmit a second signal via the second transmit antenna based at least in part on the second phase-cycling modulated sample sequence.

2. The apparatus of claim 1, wherein the instructions are further executable by the processor to cause the apparatus to:
multiply a first subsequence of the plurality of subsequences with a first phase of the first phase-cycling pattern for the first transmit antenna and the first subsequence of the plurality of subsequences with a second phase of the second phase-cycling pattern for the second transmit antenna, wherein the first phase is different from the second phase.

3. The apparatus of claim 1, wherein the instructions are further executable by the processor to cause the apparatus to:
apply the first phase-cycling pattern to a first bit of the modulated sample sequence and the second phase-cycling pattern to the first bit of the modulated sample sequence.

4. The apparatus of claim 1, wherein the instructions are further executable by the processor to cause the apparatus to:
convert the first phase-cycling modulated sample sequence to a first orthogonal frequency division multiplexing waveform and the second phase-cycling modulated sample sequence to a second orthogonal frequency division multiplexing waveform, wherein the first signal is generated based at least in part on the first orthogonal frequency division multiplexing waveform and the second signal is generated based at least in part on the second orthogonal frequency division multiplexing waveform.

5. The apparatus of claim 4, wherein the first orthogonal frequency division multiplexing waveform and the second orthogonal frequency division multiplexing waveform are mapped to resources corresponding to a single orthogonal frequency division multiplexing symbol.

6. The apparatus of claim 4, wherein the first orthogonal frequency division multiplexing waveform and the second orthogonal frequency division multiplexing waveform are mapped to resources corresponding to a plurality of orthogonal frequency division multiplexing symbols.

7. The apparatus of claim 1, wherein the first signal and the second signal are associated with a zero mean.

8. The apparatus of claim 1, wherein the first phase-cycling modulated sample sequence and the second phase-cycling modulated sample sequence are each associated with a zero mean.

9. The apparatus of claim 1, wherein the first signal and the second signal comprise low-power synchronization signals, low-power preamble signals, low-power wake-up signals, or any combination thereof.

10. The apparatus of claim 1, wherein the modulated sample sequence comprises an on-off keying sample sequence, an amplitude-shift keying sample sequence, or a frequency-shift keying sample sequence.

11. An apparatus for wireless communication at a transmitter, comprising:
a processor;
memory coupled with the processor; and
instructions stored in the memory and executable by the processor to cause the apparatus to:
modulate one or more bits into a modulated sample sequence for wireless transmission to a receiver;
generating, in accordance with a transmission staggering pattern, a first signal from the modulated sample sequence for transmission via a first transmit antenna and a second signal from the modulated sample sequence for transmission via a second transmit antenna; and
transmit the first signal via the first transmit antenna and the second signal via the second transmit antenna, wherein the first signal and the second signal are respectively transmitted via the first transmit antenna and the second transmit antenna at non-overlapping times or via non-overlapping frequencies in accordance with the transmission staggering pattern.

12. The apparatus of claim 11, wherein the transmission staggering pattern indicates to stagger the transmission of the first signal and the second signal across different frequency subbands of a resource allocation.

13. The apparatus of claim 11, wherein the instructions to transmit the first signal and the second signal are executable by the processor to cause the apparatus to:
transmit the first signal during a first portion of an on-duration of the modulated sample sequence and the second signal during a second portion of the on-duration of the modulated sample sequence, wherein the first portion and the second portion of the on-duration occur at the non-overlapping times in accordance with the transmission staggering pattern.

14. The apparatus of claim 13, wherein a first transmission power level associated with the first signal during the first portion of the on-duration is equal to a second transmission power level associated with the second signal during the second portion of the on-duration.

15. The apparatus of claim 11, wherein the instructions are further executable by the processor to transmit the first signal and the second signal by being executable by the processor to:
transmit the first signal that is a first interlace during a first portion of an on-duration of the modulated sample sequence and the second signal that is a second interlace during a second portion of the on-duration of the modulated sample sequence, wherein the first interlace and the second interlace are non-overlapping in time in accordance with the transmission staggering pattern.

16. The apparatus of claim 11, wherein the instructions are further executable by the processor to cause the apparatus to:
transmit the first signal via the first transmit antenna in a first subband of an allocated bandwidth and the second signal via the second transmit antenna using a second subband of the allocated bandwidth, wherein the first subband is different from the second subband.

17. The apparatus of claim 11, wherein the instructions are further executable by the processor to generate the first signal and the second signal by being executable by the processor to:
generating, in accordance with the transmission staggering pattern that indicate to apply a phase ramp in a frequency domain, the first signal and the second signal.

18. The apparatus of claim 11, wherein the instructions are further executable by the processor to cause the apparatus to:
convert a first staggered modulated sample sequence to a first orthogonal frequency division multiplexing waveform and a second staggered modulated sample sequence to a second orthogonal frequency division multiplexing waveform, wherein the first signal is generated based at least in part on the first orthogonal frequency division multiplexing waveform and the second signal is generated based at least in part on the second orthogonal frequency division multiplexing waveform.

19-20. (canceled)

21. The apparatus of claim 11, wherein the first signal and the second signal comprise low-power synchronization signals, low-power preamble signals, low-power wake-up signals, or any combination thereof;
wherein the modulated sample sequence comprises an on-off keying sample sequence, an amplitude-shift keying sample sequence, or a frequency-shift keying sample sequence.

22. (canceled)

23. A method for wireless communication at a transmitter, comprising:
modulating one or more bits into a modulated sample sequence for wireless transmission to a receiver;
applying a first phase-cycling pattern to a plurality of subsequences of the modulated sample sequence to generate a first phase-cycling modulated sample sequence for transmission via a first transmit antenna;
applying a second phase-cycling pattern to the plurality of subsequences of the modulated sample sequence to generate a second phase-cycling modulated sample sequence for transmission via a second transmit antenna;
transmitting a first signal via the first transmit antenna based at least in part on the first phase-cycling modulated sample sequence; and
transmitting a second signal via the second transmit antenna based at least in part on the second phase-cycling modulated sample sequence.

24-30. (canceled)
